(19) United States
(12) Patent Application Publication
(10) Pub. No.: US 2014/0297966 A1
(43) Pub. Date: Oct. 2, 2014

(54) OPERATION PROCESSING APPARATUS, INFORMATION PROCESSING APPARATUS AND METHOD OF CONTROLLING INFORMATION PROCESSING APPARATUS

(71) Applicant: FUJITSU LIMITED, Kawasaki-shi (JP)

(72) Inventors: Takahiro Aoyagi, Fostercity, CA (US); Toru Hikichi, Inagi (JP)

(73) Assignee: FUJITSU LIMITED, Kawasaki-shi (JP)

(21) Appl. No.: 14/219,077

(22) Filed: Mar. 19, 2014

(30) Foreign Application Priority Data
Mar. 29, 2013 (JP) 2013-074974

(51) Int. Cl. G06F 12/08

(52) U.S. Cl. CPC G06F 12/0815
USPC 711/141

(57) ABSTRACT

An operation processing apparatus connected with another operation processing apparatus including an operation processing unit to perform an operation process using first data administered by the own operation processing apparatus and second data administered by and acquired from another operation processing apparatus, a main memory to store the first data, and a control unit to include a setting unit which sets the operation processing unit to an operating state or a non-operating state and a cache memory which holds the first and second data, wherein when the setting unit sets the operation processing unit to the non-operating state and receives a notification related to discarding of the first data from another operation processing apparatus, the control unit acquires the first data from the main memory and holds the acquired data in the cache memory.

### CROSS-REFERENCE TO RELATED APPLICATION

This application is based upon and claims the benefit of priority of the prior Japanese Patent Application No. 2013-074974, filed on Mar. 29, 2013, the entire contents of which are incorporated herein by reference.

### FIELD

The embodiments described herein are related to an operation processing apparatus, an information processing apparatus and a method of controlling an information processing apparatus.

### BACKGROUND

An operation processing apparatus is applied to practical use for sharing data stored in a main memory among a plurality of processor cores in an information processing apparatus. Plural pairs of a processor core and an L1 cache form a group of processor cores in the information processing apparatus. A group of processor cores is connected with an L2 cache, an L2 cache control unit and a main memory. A set of the group of processor cores, the L2 cache, the L2 cache control unit and the main memory is referred to as cluster.

A cache is a storage unit with small capacity which stores data used frequently among data stored in a main memory with large capacity. When data in a main memory is temporarily stored in a cache, the frequency of access to the memory, which is time-consuming, is reduced. The cache employs a hierarchical structure in which processing at higher speed is achieved in a higher level and a larger capacity is achieved in a lower level.

In a directory-based cache coherence control scheme, the L2 cache as described above stores data requested by the group of processor cores in the cluster to which the L2 cache belongs. The group of processor cores is configured to acquire data more frequently from an L2 cache closer to the group of processor cores. In addition, data stored in a main memory is administered by the cluster to which the memory belongs in order to maintain the data consistency.

Further, the cluster administers in what state data in the memory to be administered is and in which L2 cache the data is stored according to this scheme. Moreover, when the cluster receives a request to the memory for acquiring data, the cluster performs appropriate processes for the data acquisition request based on the current state of the data. And then the cluster performs the processes for the data acquisition request and updates the information related to the state of the data.

As illustrated in Patent Document 1, a proposal is offered for reducing the latency required for an access to a main memory in an operation processing apparatus employing the above cluster structure and the above processing scheme. In Patent Document 1, when cache miss occurs in a cache and the cache does not have capacity available for storing data, data in the memory in the cluster to which the cache belongs is preferentially swept from the cache to create available capacity.

### Patent Document

[Patent document 1] Japanese Laid-Open Patent Publication No. 2000-66955

### SUMMARY

According to an aspect of the embodiments, it is provided an operation processing apparatus connected with another operation processing apparatus including an operation processing unit configured to perform an operation process using first data administered by the own operation processing apparatus and second data administered by another operation processing apparatus and acquired from another operation processing apparatus, a main memory configured to store the first data, and a control unit configured to include a setting unit which sets the operation processing unit to an operating state or a non-operating state and a cache memory which holds the first data and the second data, wherein when the setting unit sets the operation processing unit to the non-operating state and receives a notification related to discarding of the first data from another operation processing apparatus, the control unit acquires the first data which is the target of the notification from the main memory and holds the acquired data in the cache memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a part of a cluster configuration in an information processing apparatus according to a comparative example;

FIG. 2 is a diagram schematically illustrating a configuration of an L2 cache control unit according to the comparative example;

FIG. 3 is a diagram illustrating processes when a data acquisition request is generated in a cluster according to the comparative example;

FIG. 4 is a diagram illustrating processes performed in the L2 cache control unit in the processing example as illustrated in FIG. 3;

FIG. 5 is a diagram illustrating processes when a data acquisition request is generated in the cluster according to the comparative example;

FIG. 6 is a diagram illustrating processes performed in the L2 cache control unit in the comparative example as illustrated in FIG. 5;

FIG. 7 is a diagram illustrating processes performed in clusters when a Flush Back process and a Write Back process for data are performed in the comparative example;

FIG. 8 is a diagram illustrating an example of processes performed in the L2 cache control unit in the process example as illustrated in FIG. 7;

FIG. 9 is a diagram illustrating an example of processes for exclusively acquiring data in the information processing apparatus in the comparative example;

FIG. 10 is a diagram illustrating processes performed in the L2 cache control unit in the process example as illustrated in FIG. 9;

FIG. 11 is a diagram illustrating a prefetch process performed in a cluster in the comparative example;

FIG. 12 is a diagram illustrating processes performed in the L2 cache control unit in the process example as illustrated in FIG. 11;

FIG. 13 is a diagram illustrating processes performed when data evicted from the L2 cache is evacuated in the comparative example;

FIG. 14 is a diagram illustrating processes performed when the evacuated data is acquired in the comparative example;

FIG. 15 is a diagram schematically illustrating a part of a cluster configuration in an information processing apparatus according to an embodiment;

FIG. 16 is a diagram illustrating an L2 cache control unit in a cluster according to the embodiment;

FIG. 17 is a diagram illustrating an operating mode of a group of processor cores in clusters in a “mode on” state in the information processing apparatus according to the embodiment;

FIG. 18 is a diagram illustrating processes performed when data is evicted from an L2 cache belonging to a cluster which is Local to a cluster which is Remote as well as Home in the embodiment;

FIG. 19 is a diagram illustrating processes performed by the L2 cache control unit in the process example as illustrated in FIG. 18;

FIG. 20A is a diagram illustrating a circuit which the L2 cache control unit includes in the process example as illustrated in FIG. 19;

FIG. 20B is a diagram illustrating a circuit which the controller includes in the process example as illustrated in FIG. 19;

FIG. 21A is a timing chart for the L2 cache control unit in the process example as illustrated in FIGS. 18 to 20B;

FIG. 21B is a timing chart for the L2 cache control unit in the process example as illustrated in FIGS. 18 to 20B;

FIG. 22 is a diagram illustrating processes performed when data is exclusively acquired in the information processing apparatus in the embodiment;

FIG. 23 is a diagram illustrating processes performed in the L2 cache control unit in the process example as illustrated in FIG. 22;

FIG. 24 is a timing chart for the L2 cache control unit in the process example as illustrated in FIGS. 22 and 23;

FIG. 25 is a diagram illustrating an example clusters form a plurality of groups in an information processing apparatus in the embodiment; and

FIG. 26 is a diagram illustrating an example of a configuration of the L2 cache control unit according to the embodiment.

### DESCRIPTION OF EMBODIMENTS

In the above described technologies, a process for accessing a main memory to write back data to the memory is performed because cache is temporary storage. A main memory is large capacity and may be mounted on a chip different from a chip for a group of processor cores and a cache. Thus, an access to a main memory can be a bottleneck for reducing data access latency. Thus, it is an object of one aspect of the technique disclosed herein to provide an operation processing apparatus, information processing apparatus and a method of controlling an information processing apparatus to reduce the access frequency to a main memory. First, a comparative example of an information processing apparatus according to one embodiment is described with reference to the drawings.

### Comparative Example

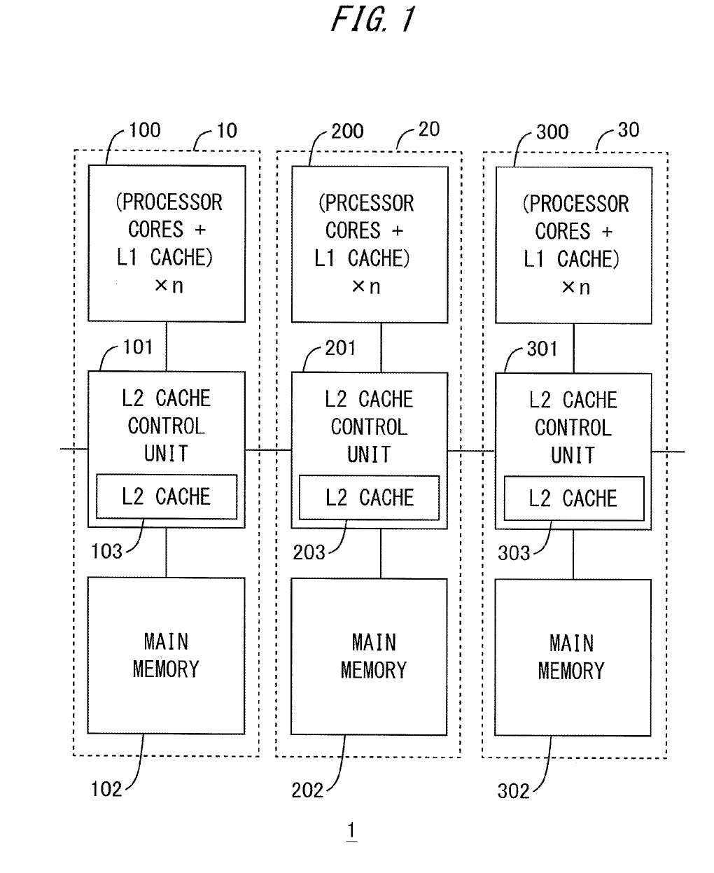

FIG. 1 illustrates a part of a cluster configuration in an information processing apparatus according to the comparative example. As illustrated in FIG. 1, a cluster 10 includes a group of processor cores 100 which include n (n is a natural number) combinations of an processor core and an L1 cache, an L2 cache control unit 101 and a main memory 102. The L2 cache control unit 101 includes an L2 cache 103. Similar to the cluster 10, clusters 20 and 30 also include groups of processor cores 200 and 300, L2 cache control units 201 and 301, memories 202 and 302, and L2 caches 203 and 303 respectively.

In the following descriptions, a cluster to which an processor core requesting data stored in a main memory belongs is referred to as Local (cluster). In addition, a cluster to which the memory storing the requested data belongs is referred to as Home (cluster). Further, a cluster which is not Local and holds the requested data is referred to as Remote (cluster). Therefore, each cluster can be Local, Home and/or Remote according to where data is requested to or from. Moreover, a Local cluster also functions as Home in some cases for performing processes related to a data acquisition request. And a Remote cluster also functions as Home in some cases. Additionally, the state information of data stored in a main memory administered by a Home cluster is referred to as directory information. The details of the above components are described later.

As illustrated in FIG. 1, an L2 cache control unit in each cluster is connected with another L2 cache control unit via a bus or an interconnect. In the information processing apparatus 1, since the memory space is so-called flat, it is uniquely determined by physical addresses which data is stored in a main memory and which cluster the memory belongs to.

For example, when the cluster 10 acquires data stored not in the memory 102 but in the memory 202, the cluster 10 sends a data request to the cluster 20, to which the memory 202 storing the data belongs. The cluster 20 checks the state of the data. Here, the state of data means the status of use of the data such as in which cluster the data is stored, whether or not the data is being exclusively used, and in what state the synchronization of the data is in the information processing apparatus 1. In addition, when the data to be acquired is stored in the L2 cache 203 belonging to the cluster 20 and the synchronization of the data is established in the information processing apparatus 1, the cluster 20 sends the data to the cluster 10 requesting the data. And then the cluster 20 records in the state information of the data that the data is sent to the cluster 10 and the data is synchronized in the information processing apparatus 1.

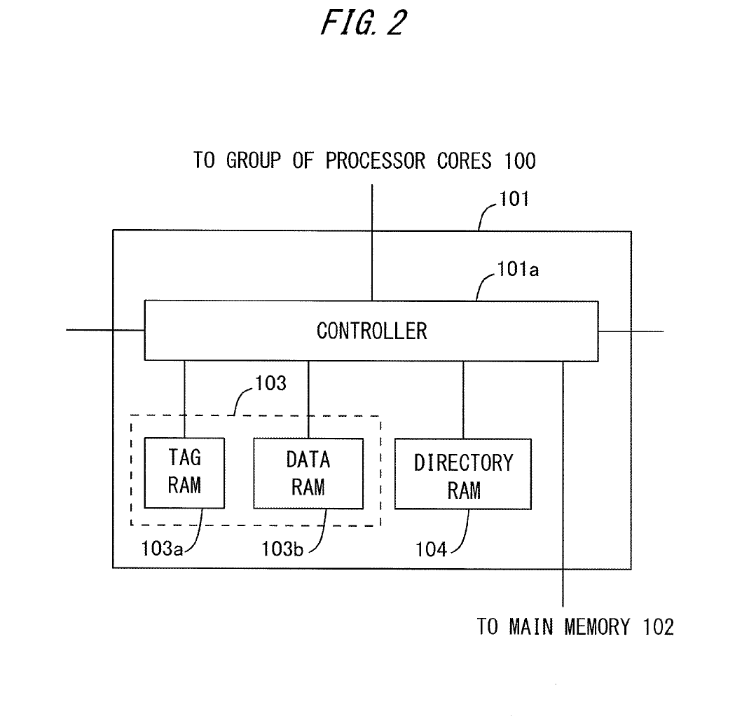

FIG. 2 schematically illustrates a configuration of the L2 cache control unit 101. The L2 cache control unit 101 includes a controller 101a, an L2 cache 103 and a directory RAM 104. In addition, the L2 cache 103 includes a tag RAM 103a and a data RAM 103b. The tag RAM 103a holds tag information of blocks held by the data RAM 103b. The tag information means information related to the status of use of each data, addresses in a main memory and the like in the coherence protocol control. In a multiple processor environment, in which a plurality of processors are used, it is more likely that processors share the same data and access to the data. Therefore, the consistency of data stored in each cache is maintained in the multiple processor environment. A protocol for maintaining the consistency of data among processors is referred to as coherence protocol. MESI protocol is one example of such a protocol. In the following descriptions, MESI protocol, which administers the status of use of data with four states, Modified, Exclusive, Shared and Invalid, is used. However, available protocols are not limited to this protocol.

The controller 101a uses the tag RAM 103a to check in which state a main memory block is stored in the data RAM 103b and the presence of data. The data RAM 103b is a RAM for holding a copy of data stored in the memory 102, for example. The directory RAM 104 is a RAM for handling the directory information of a main memory which belongs to a Home cluster. Since the directory information is a large amount of information, the directory information is stored in a main memory and a cache for the memory is arranged in the RAM in many cases. However, the directory information of the memory which belongs to the Home cluster is stored in the directory RAM 104 in the present embodiment.

The controller 101a accepts requests from the group of processor cores 100 or controllers in L2 cache control units in other clusters. The controller 101a sends operation requests to the tag RAM 103a, the data RAM 103b, the directory RAM 104, the memory 102 or other clusters according to the contents of received requests. And when the requested operations are completed, the controller 101a returns the operation results to the requestors of the operations.

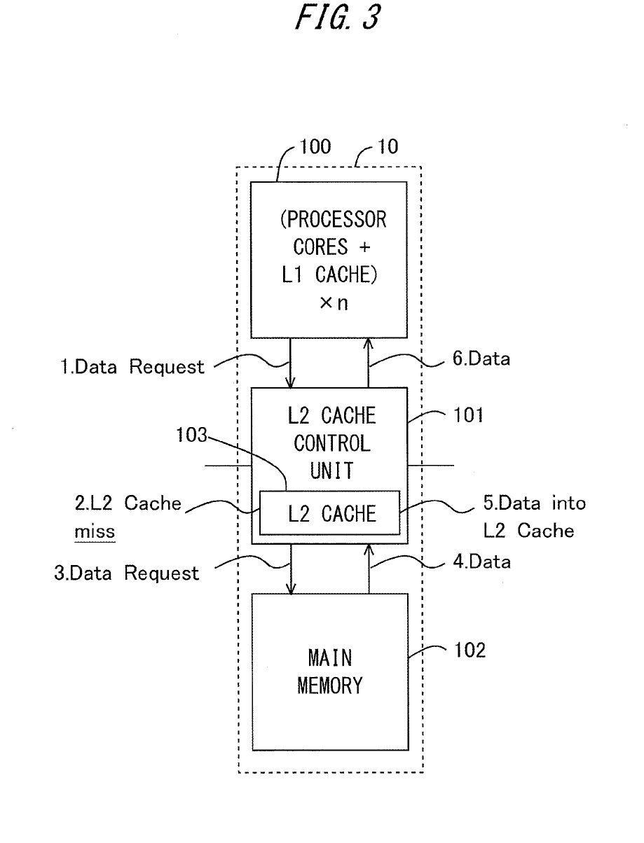

FIG. 3 is a diagram illustrating an example of processes performed when a data acquisition request is generated in the cluster 10. The cluster 10 is a Local cluster and a Home cluster in FIG. 3. FIG. 3 illustrates processes performed when a data acquisition request to the memory 102 which belongs to the cluster 10 is generated and cache miss occurs in the L2 cache 103. It is assumed here that the cache miss occurs in the L1 cache when the L2 cache control unit receives the data acquisition request.

A request of data is sent from an processor core in the cluster 10 which is Local to the L2 cache control unit 101. When the L2 cache control unit 101 in the cluster 10 which is also Home determines that the L2 cache 103 does not hold the data (miss), the L2 cache control unit 101 refers to the directory information stored in the directory RAM 104. And then the L2 cache control unit 101 checks based on the directory information whether or not the data is held by an L2 cache in a Remote cluster. When the L2 cache control unit 101 determines that the L2 cache in the Remote cluster does not hold the data (miss), the L2 cache control unit 101 requests data acquisition to the memory 102 in the cluster 10 which is Local. When the memory 102 returns the data to the L2 cache control unit 101, the L2 cache control unit 101 stores the data in the data RAM 103b in the L2 cache 103. In addition, the L2 cache control unit 101 sends the data to the processor core requesting the data in the group of processor cores 100. Further, the tag RAM 103a in the L2 cache stores information indicating that the data is acquired in the state in which the data is synchronized in the information processing apparatus 1. Further, the directory RAM 104 stores information indicating that the data is held by the cluster 10 which is Local.

When the L2 cache control unit 101 refers to the tag RAM 103a to determine that the data RAM 103b in the L2 cache 103 does not have capacity for storing data, the L2 cache control unit 101 evicts data from the L2 cache 103 according to a predetermined algorithm including a random algorithm and LRU (Least Recently Used) algorithm. When the L2 cache control unit 101 refers to the tag RAM 103a to determine that the data to be evicted is in the state similar to the data stored in the memory 102, the L2 cache control unit 101 discards the data to be evicted. On the other hand, when the L2 cache control unit 101 refers to the tag RAM 103a to determine that the data to be evicted has been updated, the L2 cache control unit 101 writes back the data to be evicted to the memory 102.

Thus, the data requested by the processor core in the group of processor cores 100 is stored in free space in the data RAM 103b in the L2 cache 103. Additionally, when an processor core in the group of processor cores 100 generates a data acquisition request for the data again, the L2 cache control unit 101 holds the data stored in the data RAM 103b and sends the data to the processor core (hit). Therefore, as long as the data is not evicted from the data RAM 103b, the L2 cache control unit 101 does not access to the memory 102.

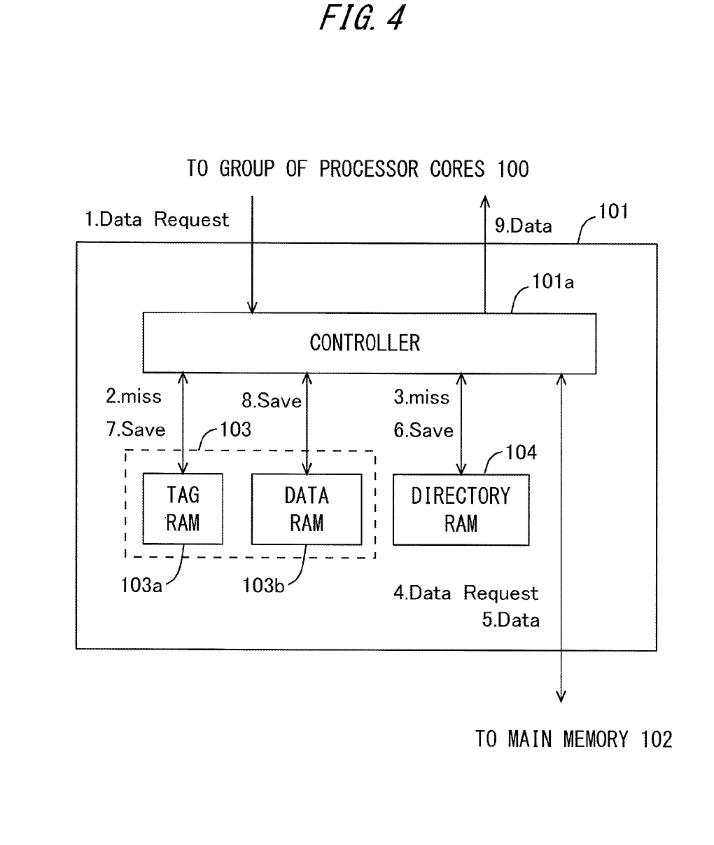

FIG. 4 is a diagram illustrating processes performed in the L2 cache control unit 101 in the process example as illustrated in FIG. 3. The controller 101a accepts a data acquisition request from an processor core in the group of processor cores 100. The data acquisition request contains the information indicating that the request is generated by the processor core, the type of the data acquisition request and the address in the memory storing the data. The controller 101a initiates appropriate processes according to the contents of the request.

First, the controller 101a checks the tag RAM 103a to determine whether or not a copy of a block of a main memory which stores the data as the target of the data acquisition request is found in the data RAM 103b. When the controller 101a receives a result indicating that the copy is not found (miss) from the tag RAM 103a, the controller 101a refers to the directory RAM 104 to check whether or not the data as the target of the data acquisition request is held by Remote clusters. The controller 101a receives a result indicating that the data is not held by clusters (miss) from the directory RAM 104, the controller 101a sends a data acquisition request of the data to the memory 102. When the controller 101a receives the data from the memory 102, the controller 101a registers in the directory RAM 104 information indicating that the data is held by a Home cluster. In addition, the controller 101a stores information of the status of use of the data (“Shared” etc.) in the tag RAM 103a. Further, the controller 101a stores the data in the data RAM 103b. Moreover, the controller 101a sends the data to the processor core requesting the data in the group of processor cores 100.

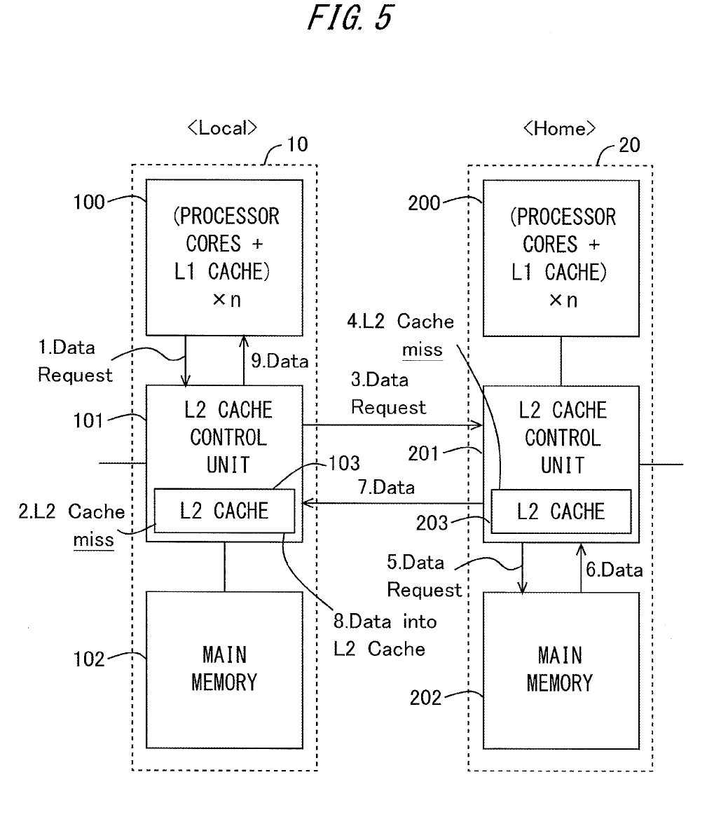

Next, FIG. 5 is a diagram illustrating an example of processes performed when a data acquisition request is generated in the cluster 10. In the example as illustrated in FIG. 5, the cluster 10 is a Local cluster and the cluster 20 is a Home cluster. An processor core in the group of processor cores 100 in the cluster 10 which is Local sends a data acquisition request to the L2 cache 103 in the cluster 10. And cache miss occurs (miss) because the requested data is not stored in the L2 cache 103. Thus, the cluster 10 sends a data acquisition request for the data to the cluster 20 which is Home. The L2 cache control unit 201 in the cluster 20 checks the directory information stored in the L2 cache 203. When the controller 201a in the L2 cache control unit 201 determines that the data is not stored in the L2 cache 203 and in L2 caches in Remote clusters (miss), the controller 201a sends a data acquisition request for the data to the memory 202.

When the memory 202 returns the data to the L2 cache control unit 201, the L2 cache control unit 201 updates the directory information stored in the directory RAM 204. And the L2 cache control unit 201 sends the data to the cluster 10 which is Local and requesting the data. The L2 cache control unit 101 in the cluster 10 stores in the L2 cache 103 the data received from the L2 cache control unit 201 in the cluster 20. And then the L2 cache control unit 101 sends the data to the processor core requesting the data in the group of processor cores 100.

Here, the data is not stored in the L2 cache 203 in the cluster 20 which is Home for the following reasons. First, the data is requested from an processor core in the cluster 10 which is Local and not requested from an processor core in the cluster 20 which is Home. Second, when the data is stored in the L2 cache 203 in the cluster 20 which is Home, this means that data which is not used by the group of processor cores 200 in the cluster 20 which is Home is stored in the L2 cache 203. Third, when such unused data is stored in the L2 cache 203, data used by the group of processor cores 200 may be evicted from the L2 cache 203.

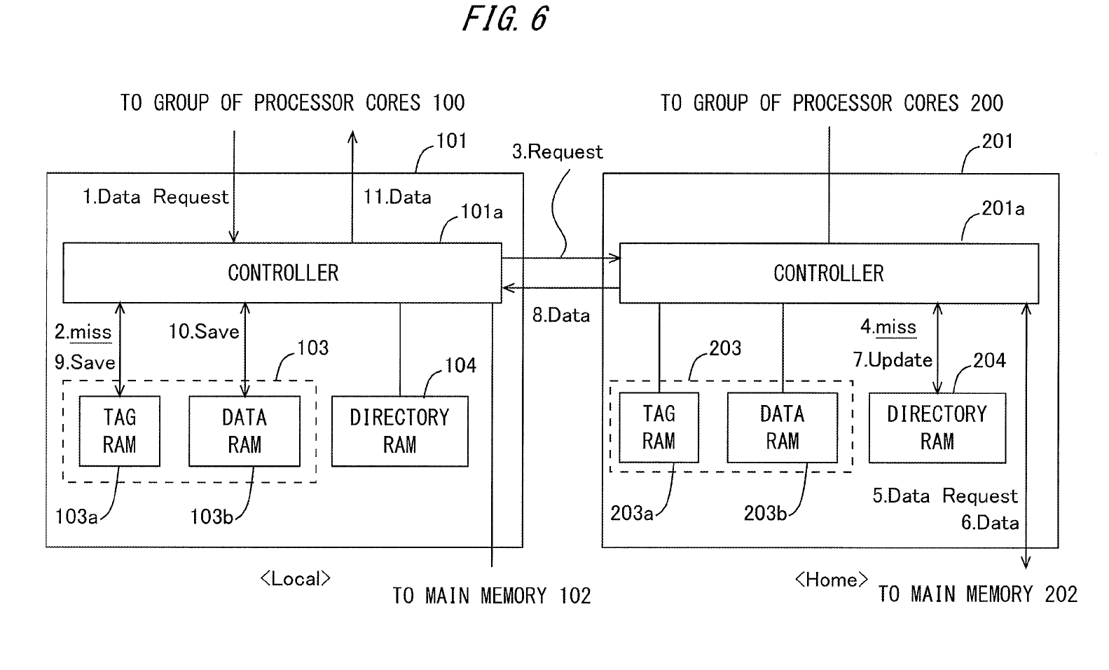

FIG. 6 is a diagram illustrating processes performed by the L2 cache control units 101 and 201 in the example as illustrated in FIG. 5. The controller 101a in the L2 cache control unit 101 in the cluster 10 which is Local accepts a data acquisition request from an processor core in the group of processor cores 100. The data acquisition request includes the information indicating that the request is generated by the processor core, the type of the data acquisition request and the address in the memory storing the data. The controller 101a initiates appropriate processes according to the contents of the request.

The controller 101a checks the tag RAM 103a whether or not a copy of a block of a main memory which stores data as the target of the data acquisition request is found in the data RAM 103b. When the controller 101a receives a result indicating that the copy is not found (miss) from the tag RAM 103a, the controller 101a sends a data acquisition request of the data to the controller 201a in the L2 cache control unit 201 which belongs to the cluster 20 which is Home.

When the controller 201a receives the data acquisition request, the controller 201a checks the directory RAM 204 whether or not the data as the target of the data acquisition request is stored in an L2 cache in any cluster. When the controller 201a receives a result indicating that the data is not found in clusters (miss) from the directory RAM 204, the controller 201a sends a data acquisition request for the data to the memory 202. When the memory 202 returns the data to the controller 201a, the controller 201a stores as the status of use of the data in the directory RAM 204 the information indicating that the data is held by the cluster 10 requesting the data. And then the controller 201a sends the data to the controller 101a in the cluster 10 requesting the data. When the controller 101a in the cluster 10 receives the data, the controller 101a stores the status of use of the data (“Shared” etc.) in the tag RAM 103a. In addition, the controller 101a stores the data in the data RAM 103b. Further, the controller 101a sends the data to the processor core requesting the data in the group of processor cores 100.

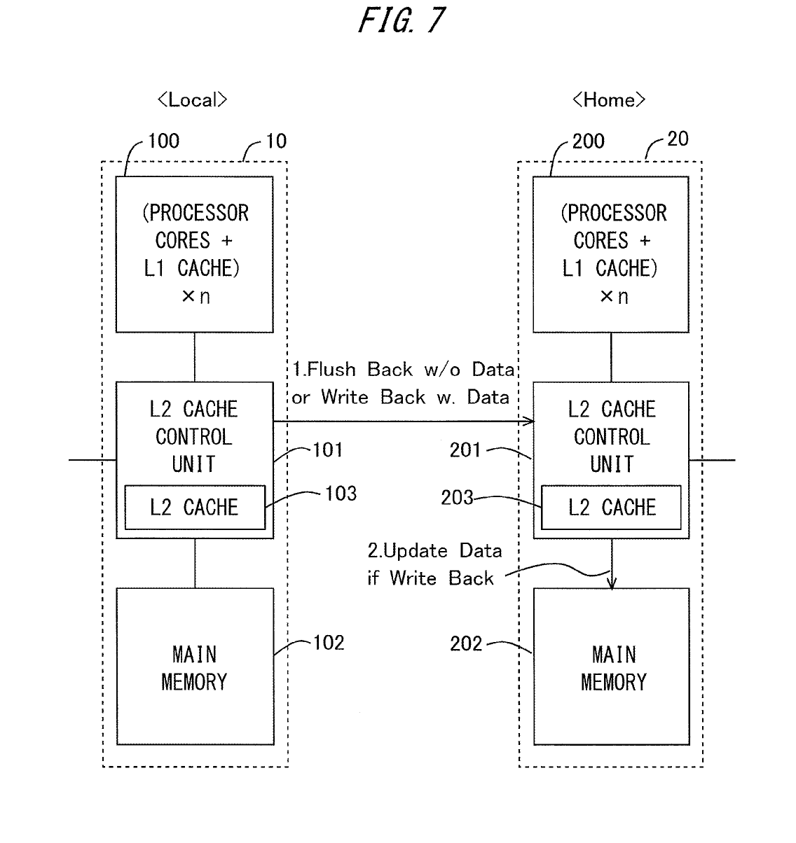

FIG. 7 is a diagram illustrating processes performed by clusters when Flush Back or Write Back for data to a Remote cluster is executed in the comparative example. Flush Back to a Remote cluster means processes performed when a cluster evicts from the cache the data acquired from another cluster. Flush Back also means processes for notifying the Home cluster that the data is evicted from the cluster which is not only Local but also Remote for the Home cluster when the evicted data is not updated and is synchronized in the information processing apparatus 1, that is, the evicted data is clean. The processes are performed for the Home cluster to update the directory information. Moreover, Write Back to a Remote cluster means processes performed when a cluster evicts data acquired from another cluster from the cache in the cluster. Write Back also means processes for notifying another cluster that the data is so-called “dirty” when the evicted data is updated and is not synchronized in the information processing apparatus 1, that is, the evicted data is dirty. As described below, when a cluster executes Flush Back to a Remote cluster in the comparative example, the cluster sends a Flush Back request to the cluster from which the data is acquired and does not send the data to the cluster from which the data is acquired. To the contrary, when the cluster executes Write Back to a Remote cluster in the comparative example, the cluster sends a Write Back request to the cluster from which the data is acquired and also sends the data to the cluster from which the data is acquired so that the cluster from which the data is acquired stores the data in the memory.

As described above, when new data is stored in an L2 cache and the L2 cache does not have capacity for the data, data stored in the L2 cache is evicted according to a predetermined algorithm. In FIG. 7, the cluster 10 is a Local cluster and the cluster 20 is a Home cluster. It is noted that the cluster 20 is also a Remote cluster in the example. Further, clusters in the information processing apparatus 1 which are not depicted in FIG. 7 are Remote. Moreover, in FIG. 7, the cluster 10 evicts the data to be stored in the memory 202 in the cluster 20 which is Remote among the data stored in the data RAM 103b since the data RAM 103b in the L2 cache 103 which belongs to the cluster 10 which is Local does not have data capacity.

In this case, as illustrated in FIG. 7, the L2 cache control unit 101 in the cluster 10 sends a request for evicting the data from the L2 cache 103 to the L2 cache control unit 201 in the cluster 20. This request is a Flush Back request or a Write Back request. It is noted that the Flush Back request and the Write Back request are examples of predetermined requests. In addition, when data to be evicted is clean, a Flush Back request is sent to the L2 cache control unit 201 in the cluster 20 which is Home. The L2 cache control unit 201 stores in the directory information in the L2 cache control unit 201 information indicating that the data is evicted from the cluster 10 requesting the data.

On the other hand, when the data to be evicted is dirty, a Write Back request and the data are sent to the L2 cache control unit 201 in the cluster 20 which is Home. For example, when data is updated by the group of processor cores 100 in the cluster 10 which is Local the data becomes dirty. In addition, the L2 cache control unit 201 stores in the directory information stored in the directory RAM 204 information indicating that the data is evicted from the cluster 10 requesting the data. The L2 cache control unit 201 writes back the data to the memory 202 which belongs to the cluster 20 which is Home. It is noted that an processor core in the cluster which is Remote requests the data to the cluster 20 which is Home. Namely, the data is not requested by the group of processor cores 200 in the cluster 20 which is Home. When the data is stored in the L2 cache 203 in the cluster 20 which is Home, other data which the group of processor cores 200 requests may be evicted from the L2 cache 203. Therefore, the data is not stored in the L2 cache 203 in the cluster 20 which is Home.

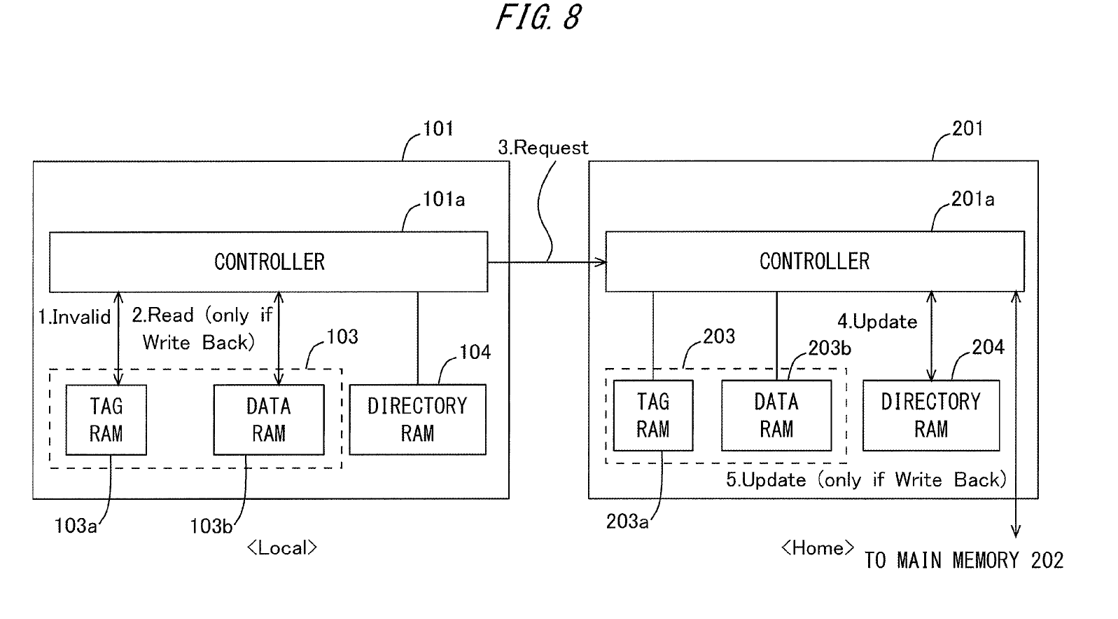

FIG. 8 is a diagram illustrating processes performed in the L2 cache control units 101 and 201 in the example as illustrated in FIG. 7. Here, processes performed after the data to be evicted from the L2 cache 103 in the L2 cache control unit 101 is determined are described. The controller 101a in the L2 cache control unit 101 requests the tag RAM 103a to invalidate the block in which the data is stored. Here, when the data is dirty and the controller 101a notifies a Write Back request to the controller 201a in the cluster 20 which is Home, the controller 101a reads data corresponding to the block from the data RAM 103b. And the controller 101a notifies a Flush Back request to the controller 201a. Alternatively, the controller 101a notifies a Write Back request to the controller 201a and sends the data to the controller 201a. When the controller 201a in the cluster 20 which is Home receives the request, the controller 201a invalidates the information in the directory RAM 204 indicating that “the data is held by the cluster 10 requesting the data”. In addition, when the controller 201a receives a Write Back request, the controller 201a writes back the data to the memory 202.

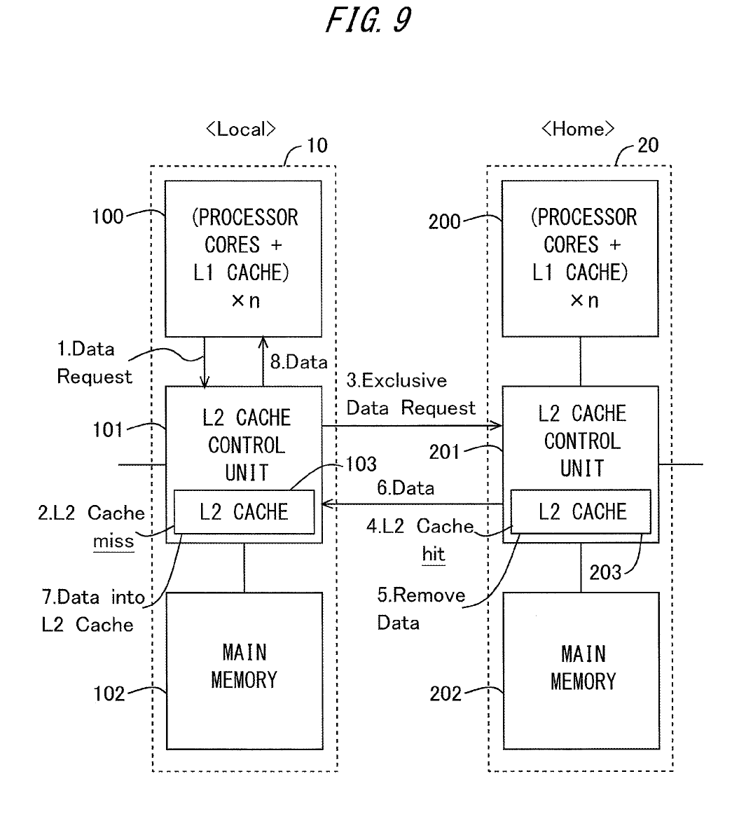

Next, FIG. 9 illustrates processes performed when the cluster 10 which is Local exclusively acquires data stored in the memory 202 in the cluster 20 which is Home. For example, when data is updated by an processor core, an exclusive data acquisition request is used. The exclusive data acquisition request is a request for ensuring that at a certain point of time one cluster (a cache in the cluster) holds the requested data and the other clusters do not hold the data. When the L2 cache in one of the other clusters holds the data when the data is updated, the data cannot be synchronized in the information processing apparatus 1. Thus, the exclusive data acquisition request is a request for preventing this situation.

First, an processor core in the group of processor cores 100 in the cluster 10 which is Local requests acquisition of data to the L2 cache control unit 101. When the L2 cache control unit 101 receives the data acquisition request, the L2 cache control unit 101 checks whether or not the data is stored in the L2 cache 103. When the data is not stored in the L2 cache 103 (miss), the L2 cache control unit 101 sends an exclusive data acquisition request for the data to the L2 cache control unit 201 in the cluster 20 which is Home. When the L2 cache control unit 201 receives the exclusive data acquisition request, the L2 cache control unit refers to the directory information stored in the L2 cache control unit 201. The directory information indicates which cluster including the Home cluster holds the data. And then the L2 cache control unit 201 sends a discard request of the data to the cluster holding the data indicated by the directory information.

In the example as illustrated in FIG. 9, the data is stored in the L2 cache 203. Therefore, the L2 cache control unit 201 discards the data from the L2 cache 203. The L2 cache control unit 201 sends the discarded data to the L2 cache control unit 101. In addition, the L2 cache control unit 201 stores in the directory information the information indicating that the cluster 10 requesting the data is a unique cluster holding the data. And then the cluster 10 requesting the data stores the data in the L2 cache 103.

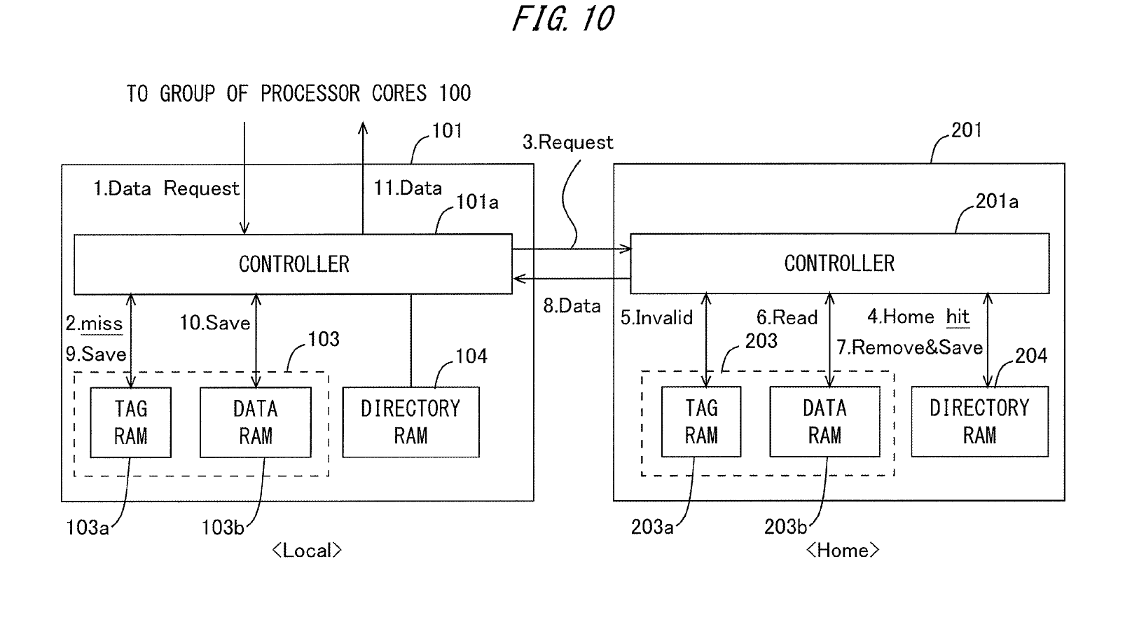

FIG. 10 is a diagram illustrating processes performed by the L2 cache control units 101 and 201 in the example as illustrated in FIG. 9. The controller 101a in the L2 cache control unit 101 in the cluster 10 which is Local accepts an exclusive data acquisition request from an processor core in the group of processor cores 100. The data acquisition request includes information indicating that the request is generated by the processor core, information indicating that the request is an exclusive data acquisition request and the address in the memory storing the data. The controller 101a initiates appropriate processes according to the contents of the request.

The controller 101a checks the tag RAM 103a to determine whether or not a copy of the block in the memory which stores the data as the target of the data acquisition request is found in the data RAM 103b. When the controller 101a receives a result indicating that the copy is not found (miss) from the tag RAM 103a, the controller 101a sends a data acquisition request of the data to the controller 201a in the L2 cache control unit 201 which belongs to the cluster 20 which is Home.

When the controller 201a receives the data acquisition request, the controller 201a checks the directory RAM 204 to determine whether or not the requested data is stored in an L2 cache in any cluster. When the controller 201a receives a result indicating that the data is held by the cluster 20 which is Home (hit), the controller 201a sends an invalidation request of the data to the tag RAM 203a. In addition, the controller 201a reads the data from the data RAM 203b. And then the controller 201a invalidates the information indicating that the data is held by a Home cluster in the directory RAM 204. Further, the controller 201a adds the information indicating that the cluster 10 requesting the data holds the data to the directory RAM 204. Moreover, the controller 201a sends the data to the controller 101a in the cluster 10 requesting the data. When the controller 101a in the cluster 10 receives the data, the controller 101a registers the status of use of the data in the tag RAM 103a. Additionally, the controller 101a stores the data in the data RAM 103b. And then the controller 101a sends the data to the processor core requesting the data in the group of processor cores.

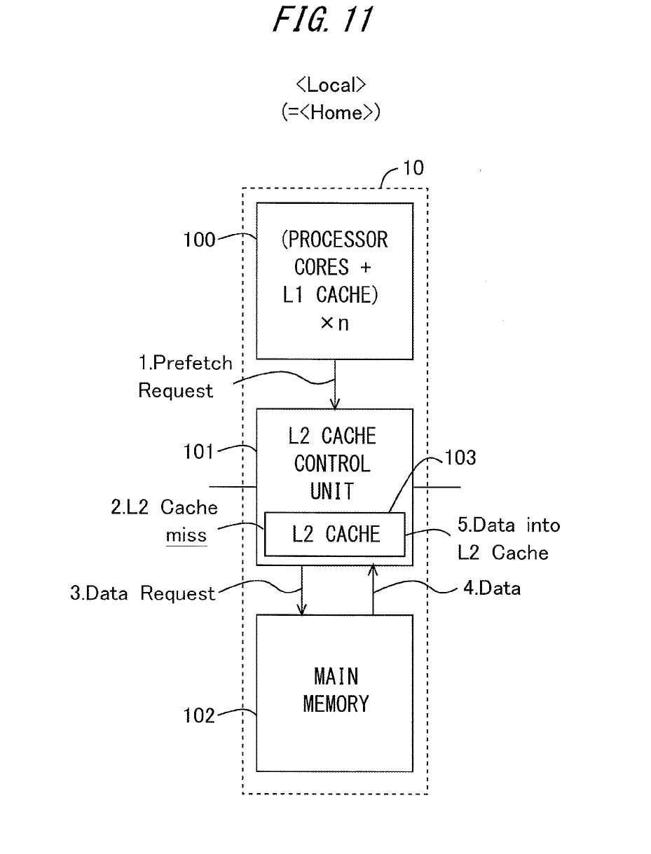

Here, it is assumed that a Local cluster is also a Home cluster. Next, FIG. 11 illustrates processes performed when the cluster 10 executes a prefetch process. Here, the prefetch process is a process for a cluster to store data to be used in the future in the L2 cache in the cluster. With this prefetch process, each cluster acquires the data from the L2 cache without accessing to the memory and sends the data to an processor core in the cluster when the processor core uses the data because the data is stored into the L2 cache in advance. As illustrated in FIG. 11, in the cluster 10, the L2 cache control unit 101 accepts a prefetch request from the group of processor cores 100. The L2 cache control unit 101 checks whether or not the data as the target of the prefetch request exists in the L2 cache 103. In addition, the L2 cache control unit 101 checks whether or not the data is held by other clusters.

When the L2 cache control unit 101 determines that the data is not found in the L2 cache 103 and not held by the other clusters, the L2 cache control unit 101 requests the data from the memory 102 because the Home cluster is also a Local cluster. When the L2 cache control unit 101 receives the data from the memory 102, the L2 cache control unit 101 stores the data in the L2 cache 103.

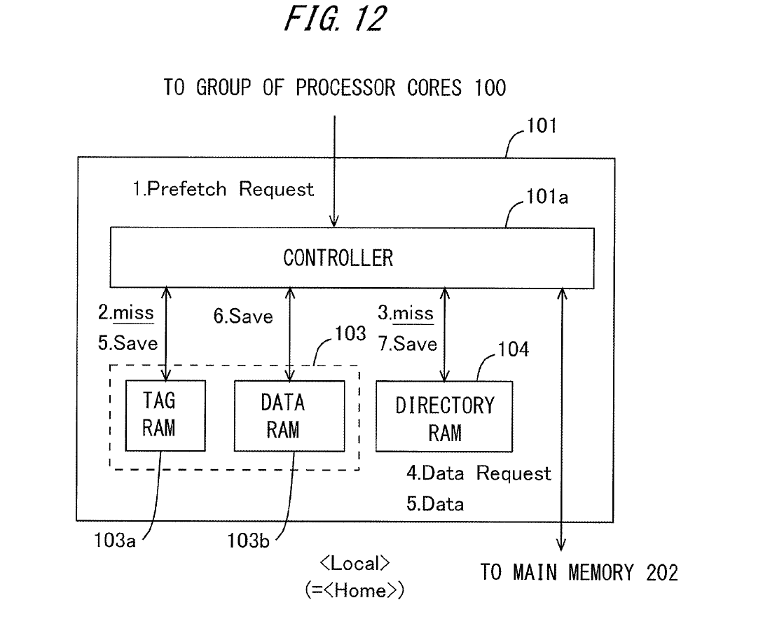

FIG. 12 illustrates processes performed when the cluster 10 executes the prefetch process as illustrated in FIG. 11. As illustrated in FIG. 12, the controller 101a of the L2 cache control unit 101 receives a prefetch request from the group of processor cores 100. And the controller 101a refers to the tag RAM 103a to check whether or not the data as the target of the prefetch process exists in the data RAM 103b. And then the controller 101a refers to the directory RAM 104 to check the status of use of the data and determines whether or not the data is held by other clusters. When the controller 101a determines that the data is not found in the data RAM 103b and not held by the other clusters, the controller 101a requests the data from the memory 102 because the Home cluster is also a Local cluster.

When the controller 101a acquires the data from the memory 102, the controller 101a requests the tag RAM 103a to register information which indicates that the data is stored in the data RAM 103b. And the controller 101a stores the data in the data RAM 103b. And then the controller 101a requests the directory RAM 104 to register information which indicates that the data is held by the cluster 10, which is a Home cluster.

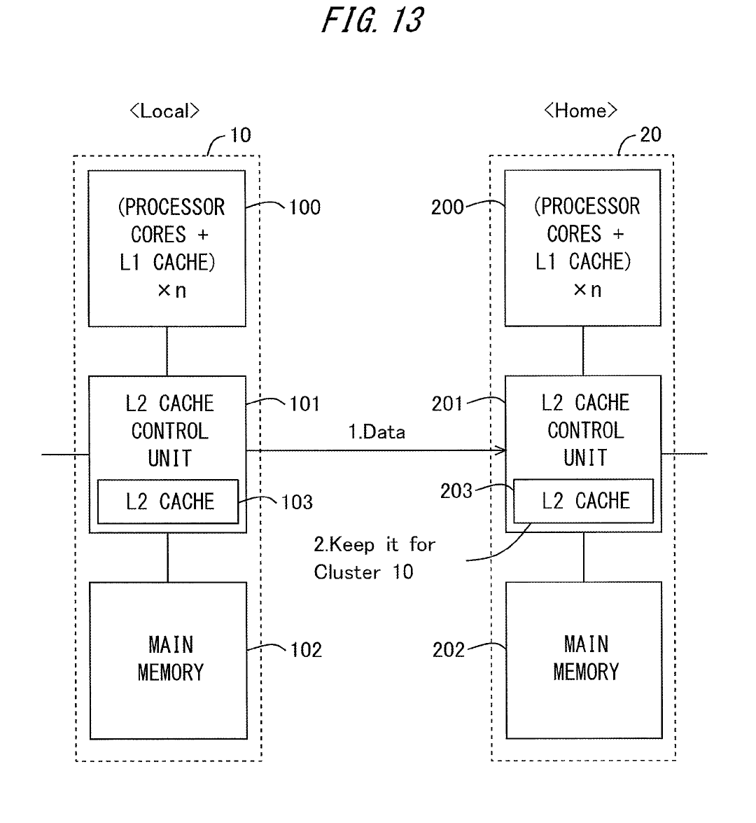

Next, FIG. 13 illustrates processes performed when the cluster 10 which is Local evicts data to be stored in the memory 202 in the cluster 20 which is Home from the L2 cache 103. As illustrated in FIG. 13, when the cluster 10 evicts data to be stored in the memory 202 in the cluster 20 from the L2 cache 103, the cluster 10 sends the evicted data to the L2 cache control unit 201. The L2 cache control unit 201 stores the received data in the L2 cache 203. Thus, in the comparative example, data evicted from a Local cluster is evacuated to an L2 cache of a Home cluster regardless of the status of use of the data.

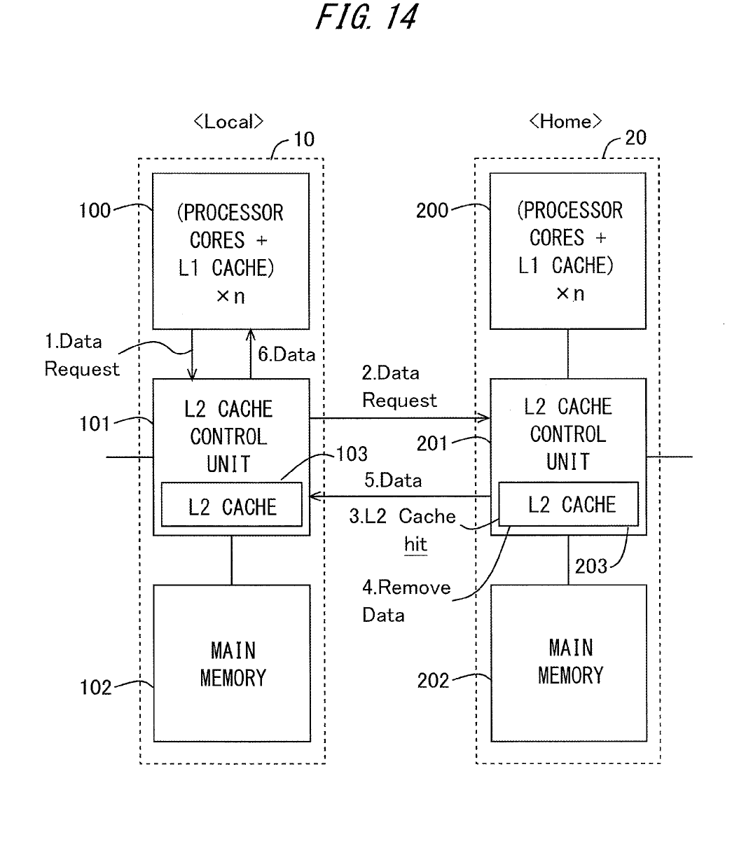

FIG. 14 illustrates processes performed when the cluster 10 which is Local acquires the data evacuated to the L2 cache 203 in the cluster 20 which is Home according to the processes as illustrated in FIG. 13. As illustrated in FIG. 14, the cluster 20 receives an acquisition request of the data evacuated from the cluster 10. And the cluster 20 determines that the requested data is found in the L2 cache 203 (cache hit). And then the cluster 20 acquires the data from the L2 cache 203 and sends the data to the cluster 10. It is noted that the L2 cache 203 is also used by the group of processor cores 200 in the cluster 20. Therefore, the cluster 20 sends the data to the cluster 10 and discards the data from the L2 cache 203 in order to effectively use the capacity of the L2 cache 203.

It is noted that the group of processor cores 200 in the cluster 20 which is Home is operating in the information processing apparatus 1 in the comparative example. Thus, the group of processor cores 100 in the cluster 10 and the group of processor cores 200 in the cluster 20 commonly use the L2 cache 203 in the cluster 20. As a result, the capacity of the L2 cache available for the group of processor cores 200 decreases. Additionally, the L2 cache 203 requires complicate controls for determining data from which group of processor cores is preferentially stored in the L2 cache 203.

Furthermore, the data evicted from the cluster 10 which is Local is sent to the cluster 20 which is Home regardless of the status of use of the data in the comparative example. That is, the data evicted from the cluster 10 is sent to the cluster 20 even when the data does not become dirty after the data is updated. This means that the data is sent to the cluster 20 even when the evicted data is synchronized in the information processing apparatus 1 (data is clean). Thus, this may lead the increase of transactions between clusters.

Moreover, the cluster 20 administers information of whether or not the data stored in the L2 cache 203 is data evacuated from the cluster 10 in the example as illustrated in FIG. 14. Therefore, in this case, a configuration is added to administer the status of use of data by using bits to indicate whether or not the data in the L2 cache 203 is evicted data. Besides, when the data evicted from the cluster 10 is acquired from the L2 cache 203, an additional flow is provided to discard the data from the L2 cache 203.

With the above descriptions of the comparative example in mind, an example of an information processing apparatus according to one embodiment is described below with reference to the drawings. In the descriptions below, the operation state and non-operation state of the group of processor cores in each cluster are controlled. Thus, while the communication traffic is not increased the probability of cache hit of data in an L2 cache can be enhanced as described later. In addition, complicated administration and control is not involved for each data stored in an L2 cache in the present embodiment. Further, a flow in which a Home cluster stores data evicted from another cluster is not performed in the present embodiment. Additionally, a flow in which data evicted from other clusters is discarded from an L2 cache in a Home cluster is not performed in the present embodiment. Moreover, each cluster does not administer whether or not data stored in the L2 cache is data evicted from another cluster in the present embodiment.

### Embodiment

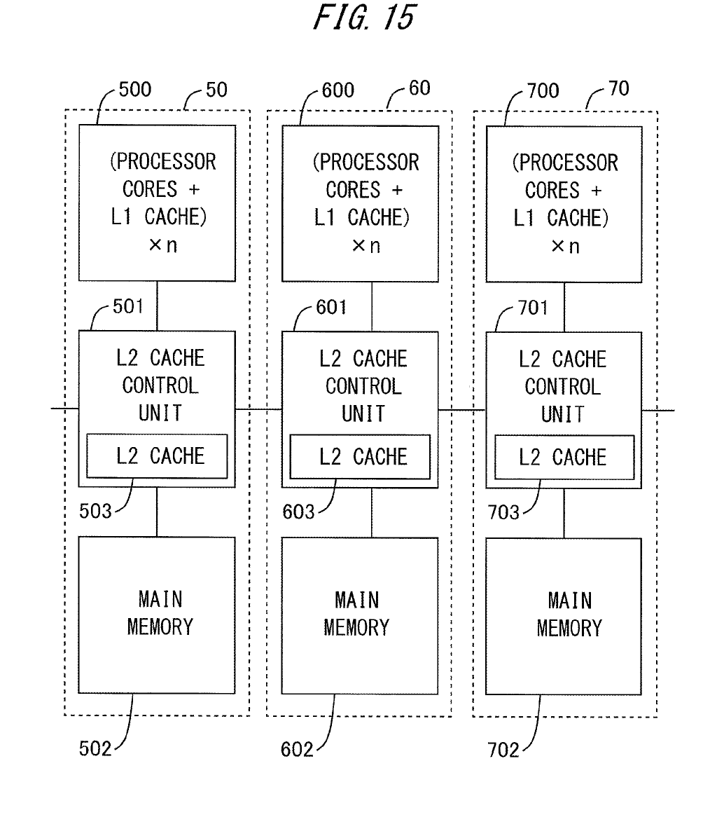

FIG. 15 schematically illustrates a part of a cluster structure in an information processing apparatus 2 according to the present embodiment. As illustrated in FIG. 15, similar to the comparative example, the information processing apparatus 2 includes clusters 50, 60 and 70. It is noted that the clusters 50, 60 and 70 are examples of operation processing apparatus. In addition, since the differences among Local, Home and Remote are as described in the above comparative example, the descriptions of the differences are omitted here. The cluster 50 includes a group of processor cores 500, an L2 cache control unit 501, a main memory 502. The L2 cache control unit 501 includes an L2 cache 503. Similar to the cluster 50, the clusters 60 and 70 also include groups of processor cores 600 and 700, L2 cache control units 601 and 701, memories 602 and 702 and L2 caches 603 and 703, respectively. The L2 cache control unit 501, 601 and 701 are examples of control units. In addition, the L2 cache 503, 603 and 703 are examples of cache memories. Further, the memories 502, 602 and 702 are examples of main memories. Moreover, the groups of processor cores 500, 600 and 700 are examples of operation processing units. Additionally, the clusters 50, 60 and 70 form a single group in the present embodiment. The group here is a group of clusters which is in charge of executing an application. However, the criteria of forming the group are not limited to this scheme and clusters can be appropriately divided into groups.

As illustrated in FIG. 15, an L2 cache controller in each cluster is connected with each other via a bus or an interconnect. In the information processing apparatus 2, the memory space is so-called flat so that it is uniquely determined according to physical addresses which data is stored and in which cluster the data is stored in a main memory.

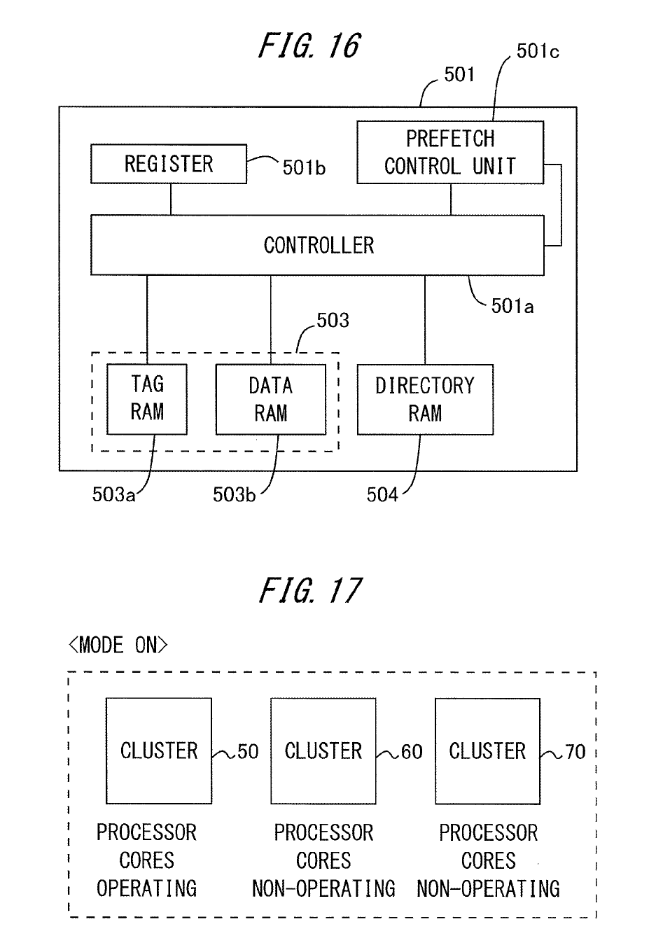

FIG. 16 is a diagram illustrating the L2 cache control unit 501 in the cluster 50. The L2 cache control unit 501 includes a controller 501a, a register 501b, the L2 cache 503 and a directory RAM 504. In addition, the L2 cache 503 includes a tag RAM 503a and a data RAM 503b. Further, the register 501b corresponds to an example of a setting unit. Moreover, the L2 cache control unit 501 includes a prefetch control unit 501c which the controller 501a uses for sending a request to the controller 501a itself. Since the functions of the tag RAM 503a, the data RAM 503b and the directory RAM 504 are similar to the comparative example, the detailed descriptions are omitted here.

The register 501b controls the operation mode of the cluster 50 in the information processing apparatus 2 according to the present embodiment. In the present embodiment, the operation mode includes, as an example, three modes which are “mode off”, “mode on and processor cores operating” and “mode on and processor cores non-operating”. The operation mode “mode off” is an operation mode in which a cluster operates as described in the above comparative example. The operation mode “mode on and processor cores operating” is an operation mode in which a cluster sets the group of processor cores to an operating state and performs processes in the present embodiment (mode on). The operation mode “mode on and processor cores non-operating” is an operation mode in which a cluster sets the group of processor cores to a non-operating state and performs processes in the present embodiment. The details of the processes in these operation modes are described later.

The controller 501a reads setting values for the register 501b and switches the operation modes according to the setting values. In addition, the operation modes are switched before application execution in the information processing apparatus 2 in the present embodiment. In addition, the OS (Operating System) of the information processing apparatus 2 controls the switching of the operation modes of the register in each cluster. It is noted that the switching of the operation modes can be performed by a user of the information processing apparatus 2 to explicitly instruct the OS or by the OS to autonomously instruct according to the information such as the memory usage of the application.

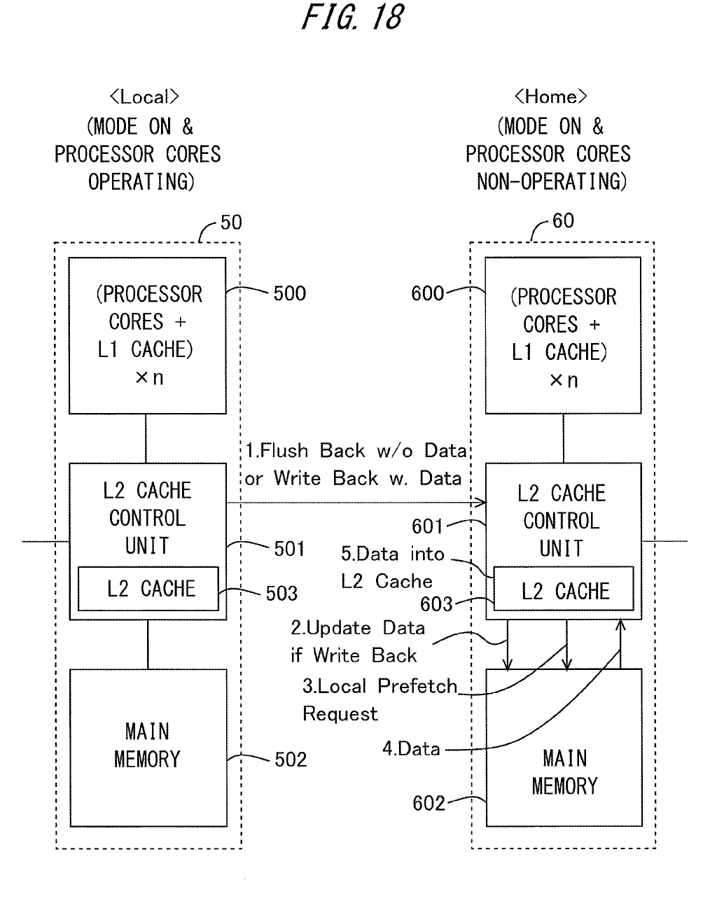

FIG. 17 is a diagram illustrating operation states of the groups of processor cores in the clusters 50, 60 and 70 when the operation mode is “mode on” in the information processing apparatus 2. As an example, the clusters 50, 60 and 70 in a group are controlled so that the group of processor cores in any one of the clusters 50, 60 and 70 operates. In FIG. 17, the operation mode of the cluster 50 is “mode on and processor cores operating” and the operation modes of the clusters 60 and 70 are “mode on and processor cores non-operating”. Thus, the group of processor cores 500 in the cluster 50 is in the operating state and the groups of processor cores 600 and 700 are in the non-operating state. As an example, a plurality of groups including clusters such as the clusters 50, 60 and 70 are formed in the information processing apparatus 2. And each group corresponds to one series of processes performed in the information processing apparatus 2.

Next, FIG. 18 is a diagram illustrating processes performed when data to be stored in the memory 602 in the cluster 60 is evicted from the L2 cache 503 which belongs to the cluster 50 according to the present embodiment. Similar to the comparative example, when the L2 cache control unit 501 stores new data in the L2 cache 503 and the L2 cache 503 does not have capacity for the data, the L2 cache control unit 501 evicts data from the L2 cache 503 according to a predetermined algorithm. The L2 cache control unit 501 refers to the tag RAM 503a to determine that the data to be evicted is clean or dirty. When it is determined that the data to be evicted is dirty, the L2 cache control unit 501 notifies a Write Back request to the L2 cache control unit 601 and sends the data to the L2 cache control unit 601. On the other hand, when it is determined that the data to be evicted is clean, the L2 cache control unit 501 notifies a Flush Back request to the L2 cache control unit 601 and sends the data to the L2 cache control unit 601. It is noted that a Write Back request and a Flush Back request are examples of requests notified when data is discarded in other operation processing apparatus.

In the present embodiment, similar to the comparative example, when the L2 cache control unit 601 receives a Write Back request, the L2 cache control unit 601 stores data received along with the request in the memory 602. In addition, the L2 cache control unit 601 updates the directory information to invalidate the information which indicates that the data is held by the cluster 10 which is Local. Further, when the L2 cache control unit 601 receives a Flush Back request, the L2 cache control unit 601 updates the directory information to invalidate the information which indicates that the data is held by the cluster 10 which is Local. And then the L2 cache control unit 601 performs a prefetch process for the data. When L2 cache control unit 601 performs a prefetch process, the L2 cache control unit 601 acquires the data from the memory 602 and stores the acquired data in the L2 cache 603.

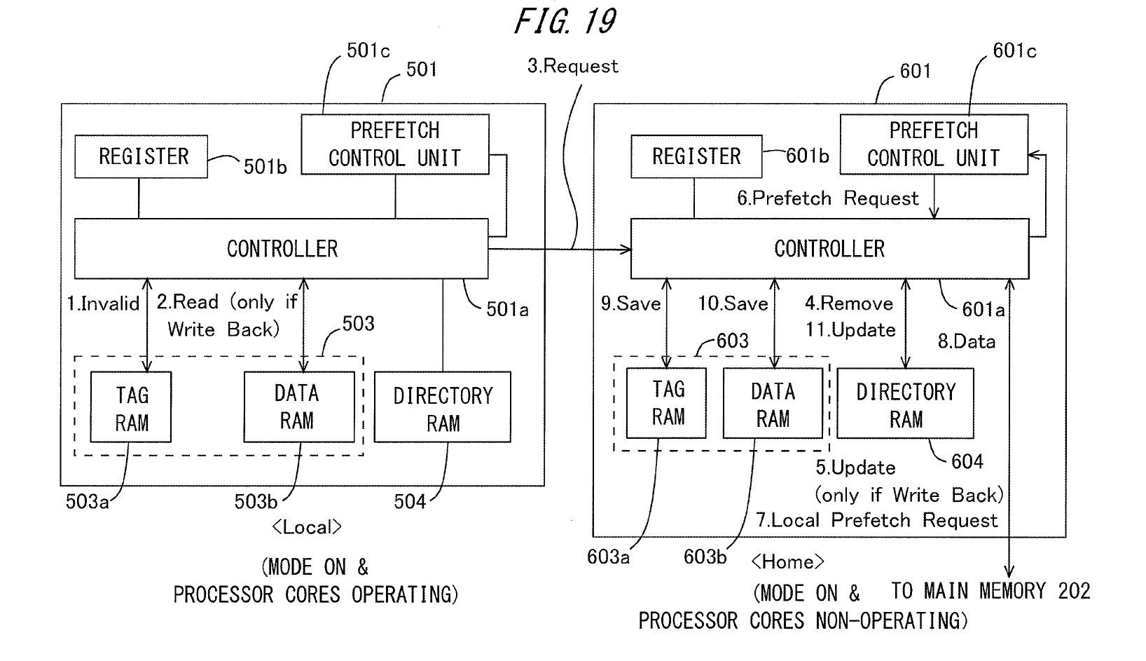

FIG. 19 is a diagram illustrating processes performed in the L2 cache control units 501 and 601 in the example as illustrated in FIG. 18. As described above, the L2 cache control units 501 and 601 include the controllers 501a and 601a, the registers 501b and 601b, the L2 caches 503 and 603 and the directory RAMs 504 and 604 respectively. In addition, the L2 caches 503 and 603 include the tag RAMs 503a and 603a and the data RAMs 503b and 603b respectively. Further, the L2 cache control unit 501 and 601 includes the prefetch control unit 501c and 601c respectively.

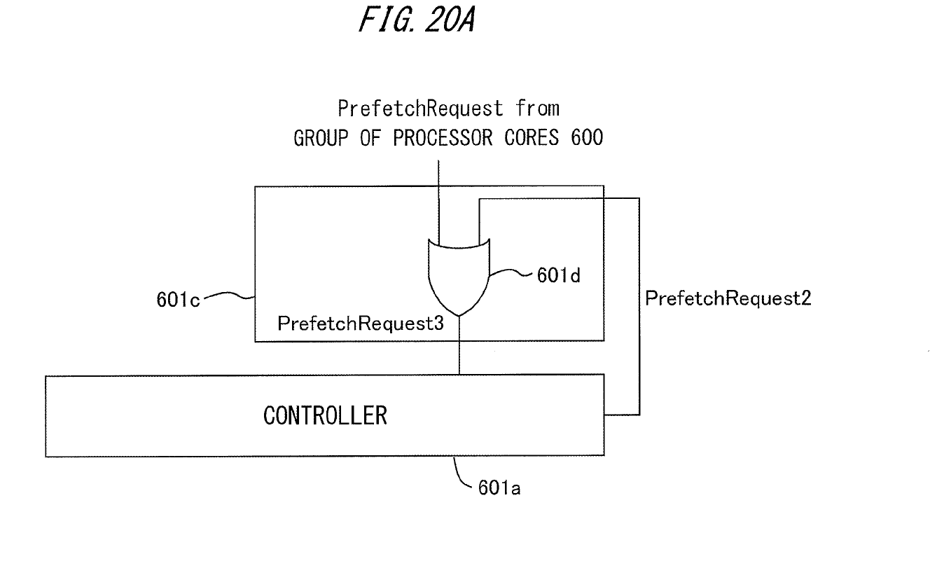

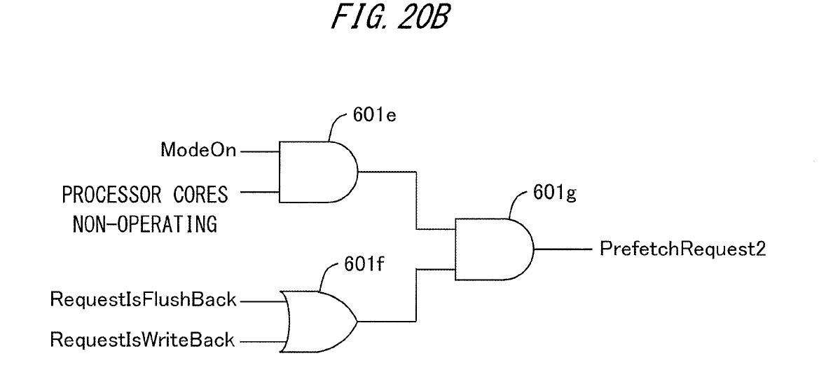

Additionally, FIG. 20A illustrates a part of a circuit in the L2 cache control unit 601 and the prefetch control unit 601c in the example as illustrated in FIGS. 18 and 19. Further, FIG. 20B illustrates a part of the circuit as illustrated in FIG. 20A and the part of the circuit is included in the controller 601a. The circuit in the controller 601a as illustrated in FIG. 20B is a control circuit functions when the cluster 60 is Home and the operation mode is “mode on and processor cores non-operating”. When the cluster 60 which is Home receives a Write Back request or a Flush Back request from the cluster 50 which is Local, a prefetch process is performed according to the control by the circuits as illustrated in FIGS. 20A and 20B. It is noted in FIGS. 20A and 20B that PrefetchRequest, which denotes performing a prefetch process is a signal for instructing an operation and the other signals are flag signals.

In FIG. 20A, an OR gate 601d of the prefetch control unit 601c outputs PrefetchRequest3 when PrefetchRequest2 is asserted by the control circuit of the controller 601a as illustrated in FIG. 20B or a prefetch request is received from the group of processor cores 600 according to the operations as described in the comparative example. In addition, in FIG. 20B, an AND gate 601e outputs “1” when the operation mode of the cluster 60 is “mode on and processor cores non-operating”. The AND gate 601e outputs “0” in other cases. In addition, an OR gate 601f outputs “1” when a signal of a Write Back request or a Flush Back request from the cluster 50 for example is asserted. An AND gate 601g outputs PrefetchRequest2, which is an instruction signal for performing a prefetch process, when both the AND gate 601e and the OR gate 601f outputs “1”. And then the output instruction signal is sent to the prefetch control unit 601c as illustrated in FIG. 20A.

Here, as illustrated in FIG. 19, the controller 501a requests the tag RAM 503a to register that the data is evicted from the data RAM 503b (Invalid). The tag RAM 503a sends to the controller 501a information indicating that the data is dirty or clean. And when the information indicates that the data is dirty, the controller 501a determines to perform a Write Back process. On the other hand, when the information indicates that the data is clean, the controller 501a determines to perform a Flush Back process. Next, the controller 501a retrieves from the data RAM 503b the data to be evicted. When the evicted data is dirty, the controller 501a notifies a Write Back request to the controller 601a and sends the evicted data to the controller 601a. On the other hand, when the evicted data is clean, the controller 501a notifies a Flush Back request to the controller 601a.

The controller 601a in the cluster 60 which is Home receives the above Write Back request or Flush Back request from the controller 501a in the cluster 50 which is Local. And then the controller 601a requests the directory RAM 604 to update the directory information to indicate that the data no longer exists in the cluster 50. When the controller 601a receives the Write Back request, the controller 601a stores in the memory 602 the data received along with the Write Back request, that is, the data evicted from the data RAM 503b.

Next, the controller 601a performs a prefetch process according to the operations of the circuits as illustrated in FIGS. 20A and 20B. The controller 601a acquires the evicted data from the memory 602. And the controller 601a requests the tag RAM 603a to update the information stored in the tag RAM 603a to indicate that the data is stored in the data RAM 603b. Next, the controller 601a stores the data in the data RAM 603b. And the controller 601a requests the directory RAM 604 to update the directory information to indicate that the data is added to the cluster 60 which is Home.

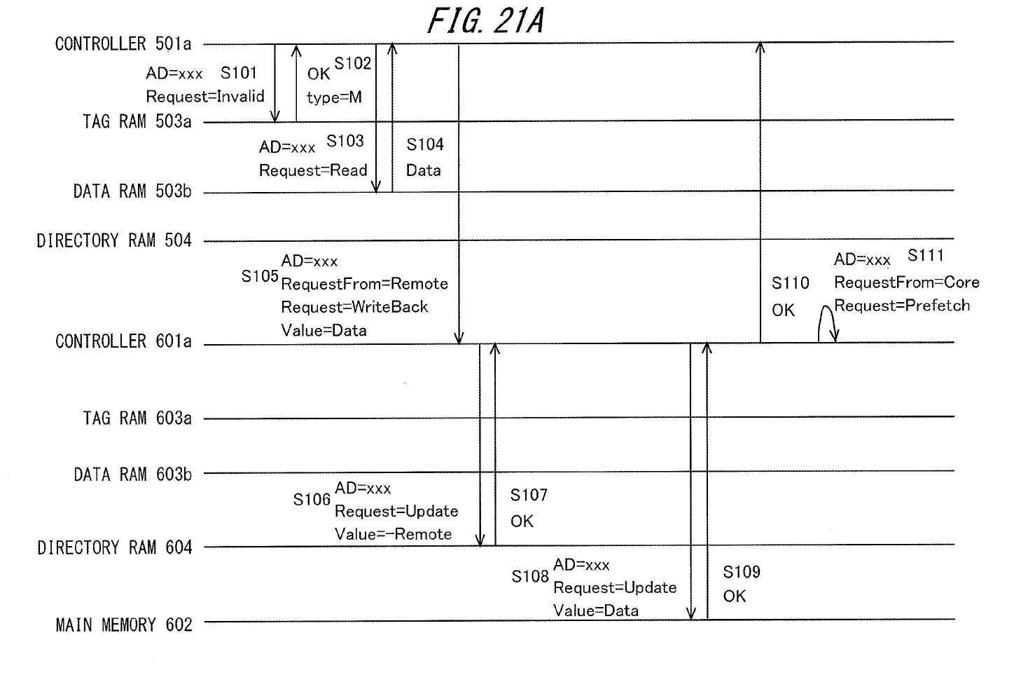

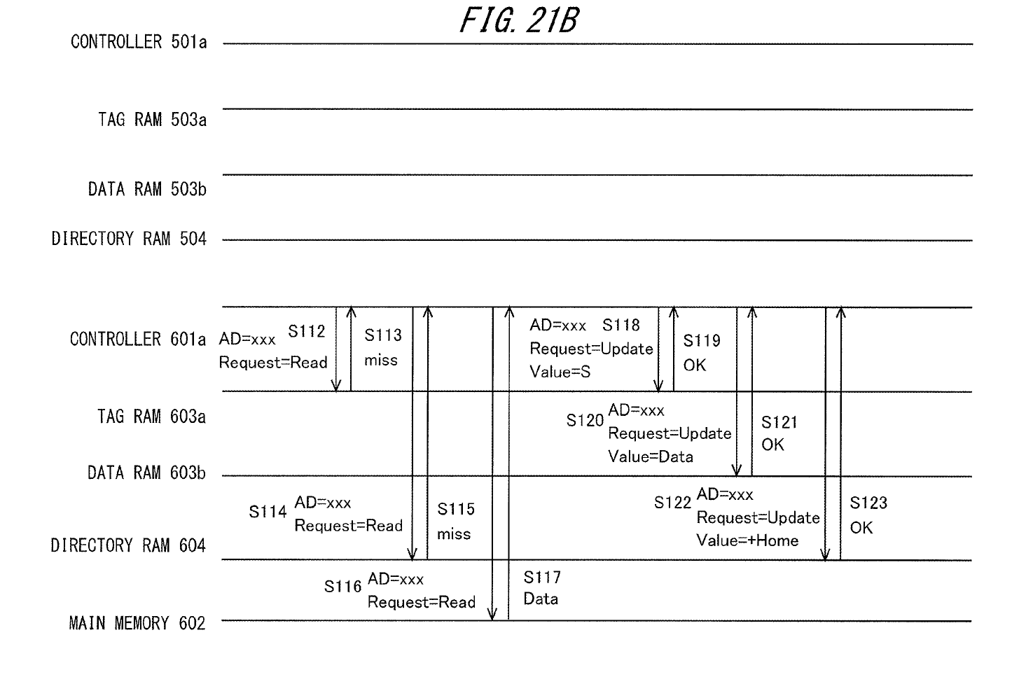

FIGS. 21A and 21B are timing charts for the L2 cache control units 501 and 601 in the example as illustrated in FIGS. 19 to 20B. In the following descriptions, a step in the timing chart is abbreviated to S. FIGS. 21A and 21B illustrate a case in which data evicted from the data RAM 503b is dirty and the controller 501a sends a Write Back request to the controller 601a. In addition, the data is not held by clusters other than the clusters 50 and 60. In S101, the controller 501a requests the tag RAM 503a to register the information which indicates that the data is evicted from the data RAM 503b (Invalid). In S102, the tag RAM 503a sends to the controller 501a the information which indicates the status of use of the data (Modified; Value=M). In S103, the controller 501a uses the address acquired from the tag RAM 503a to read the data from the data RAM 503b. In S104, the data RAM 503b reads the data of which the address matches with the address included in the request from the controller 501a and sends the data to controller 501a.

Since the status of use of the data retrieved from the tag RAM 503a in S102 is dirty, the controller 501a sends a Write Back request and the data to the controller 601a in S105. In addition, the controller 501a sends to the controller 601a the address which indicates in which cluster the data is stored in a main memory.

In S106, the controller 601a requests the directory RAM 604 to register the information which indicates that the data sent from the controller 501a is evicted from the cluster 50 (Value=−Remote). In S107, the directory RAM 604 performs the registration process according to the request from the controller 601a and notifies the controller 601a that the process is completed. In S108, the controller 601a stores the data in the memory 602. In S109, the memory 602 stores the data and notifies the controller 601a that the storing process is completed. In S110, the controller 601a notifies the controller 501a that the processes as described above are completed.

It is noted that the operation mode of the cluster 60 is “mode on and processor cores non-operating”. In addition, the controller 601a receives a Write Back request from the controller 501a. Therefore, an instruction signal of prefetch process (PrefetchRequest3) is input into the controller 601a according to the operations of the circuits as illustrated in FIGS. 20A and 20B. Thus, in S111 the controller 601a performs a prefetch process.

FIG. 21B illustrates processes performed by the controller 601a subsequent to S111. In S112, the controller 601a requests the tag RAM 603a to check whether or not the data evicted from the cluster 50 as described above is stored in the data RAM 603b. In S113, the tag RAM 603a notifies the controller 601a that the data is not stored in the data RAM 603b (miss). In S114, the controller 601a requests the directory RAM 604 to check whether or not the data is held by other clusters. In S115, the directory RAM 604 notifies the controller 601a that the data is not held by other clusters (miss).

When the controller 601a determines that the data is not stored in the data RAM 603b and not held by other clusters, the controller 601a requests the data from the memory 602 in S116. In S117, the memory 602 retrieves the requested data and sends the data to the controller 601a. In S118, the controller 601a requests the tag RAM 603a to update the information stored in the tag RAM 603a to indicate that the acquired data is stored in the data RAM 603b. In this case, the controller 601a also requests the tag RAM 603a to register information which indicates that the status of use of the data is “Shared”. In S119, the tag RAM 603a updates the information according to the update request and notifies the controller 601a that the update process is completed.

In S120, the controller 601a stores the data acquired from the memory 602 in S117 in the data RAM 603b. In S121, the data RAM 603b stores the data and notifies the controller 601a that the storage process is completed. In S122, the controller 601a requests the directory RAM 604 to update the directory information to indicate that the data is held by the cluster 60 which is Home (Value=+Home). In S123, the directory RAM 604 updates the directory information according to the update request and notifies the controller 601a that the update process is completed.

As described above, the cluster which is Remote as well as Home performs a prefetch process when the cluster receives a Flush Back request or a Write Back request from a Local cluster in the present embodiment. Thus, additional data flows are not configured for processes performed between clusters. In addition, when data is evicted from a Local cluster, the information processing apparatus 2 can transfer the data to an L2 cache in the cluster which is Remote as well as Home in the present embodiment. Therefore, when the Local cluster requires the data again and requests the data from the cluster which is Remote as well as Home, the cluster which is Remote as well as Home acquires the data from the L2 cache. That is, the cluster which is Remote as well as Home can acquire the data without access to the memory. Therefore, the latency associated with the memory access can be reduced than the latency in the comparative example. Further, similar to the comparative example, data evicted from a Local cluster is transmitted to a cluster which is Remote as well as Home when a Write Back request is performed in the present embodiment. Therefore, there is not a concern for the increase of transactions between clusters in the present embodiment.

It is noted that in the present embodiment a directory RAM uses the directory information to administer which cluster retrieves each data stored in a data RAM by use of a bit corresponding to each cluster. For example, for each data a bit “1” is used for a cluster which holds the data and a bit “0” is used for a cluster which does not hold the data. Therefore, for example, in S110 as described above, the directory RAM 604 sets the bit for the cluster 60 to “1” and sets the bit for the cluster 50 to “0”. In the following descriptions, a directory RAM changes the bits in the directory information to register the status of use of each data. However, the configuration for administering the status of data retrieved by clusters in the directory RAM is not limited to the above embodiment. Since the processes performed by the controller 601a are the same as above when the controller 501a sends a Flush Back request to the controller 601a, the detailed descriptions of the processes are omitted here.

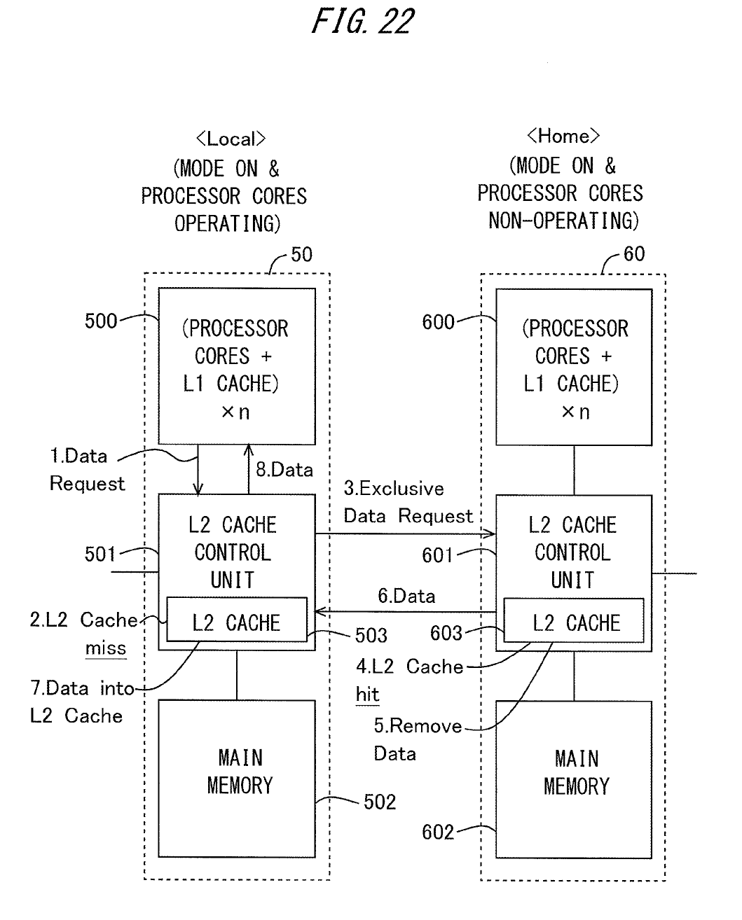

Next, FIG. 22 is a diagram illustrating processes performed when the cluster 50 which is Local acquires data stored in the memory 602 in the cluster 60 which is Home. It is noted that the operation mode of the cluster 50 which is Local is “mode on and processor cores operating”. In the present embodiment, the cluster 50 which is Local performs an exclusive data acquisition request when the cluster 50 requests data from other clusters. FIG. 22 illustrates a case in which the requested data is stored in the L2 cache 603. Therefore, when the L2 cache control unit 601 receives an exclusive data acquisition request from the L2 cache control unit 501, the L2 cache control unit 601 acquires the data from the L2 cache 603. And the L2 cache control unit 601 sends the acquired data to the L2 cache control unit 501. In addition, the L2 cache control unit 601 discards the data from the L2 cache 603. And then the L2 cache control unit 501 stores the data received from the L2 cache control unit 601 in the L2 cache 503 and sends the data to the group of processor cores 500.

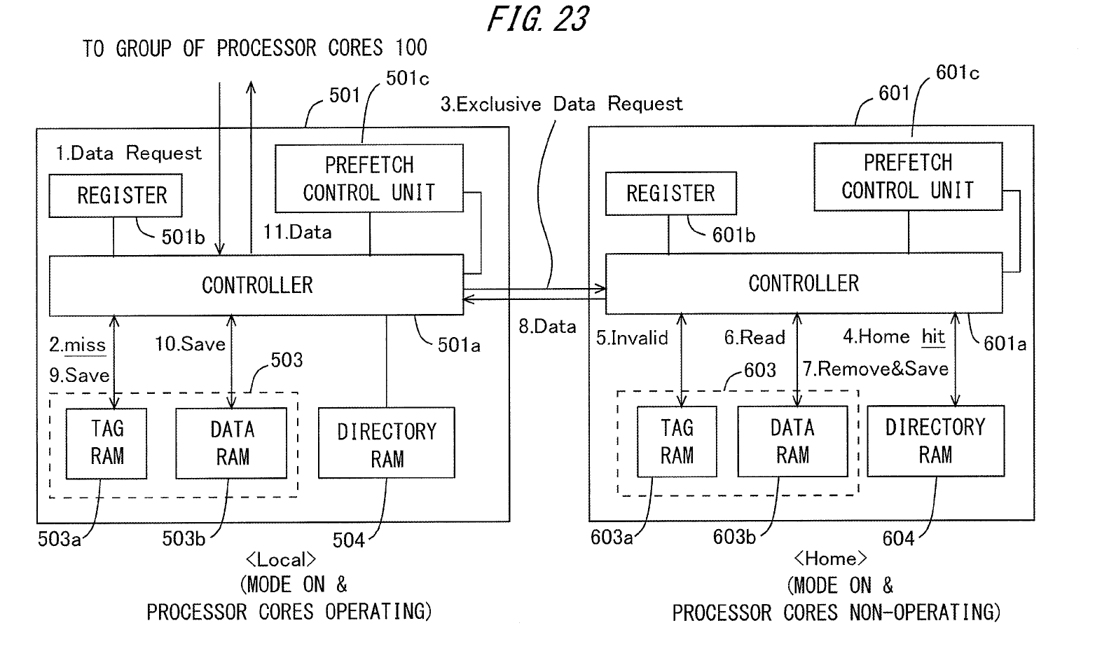

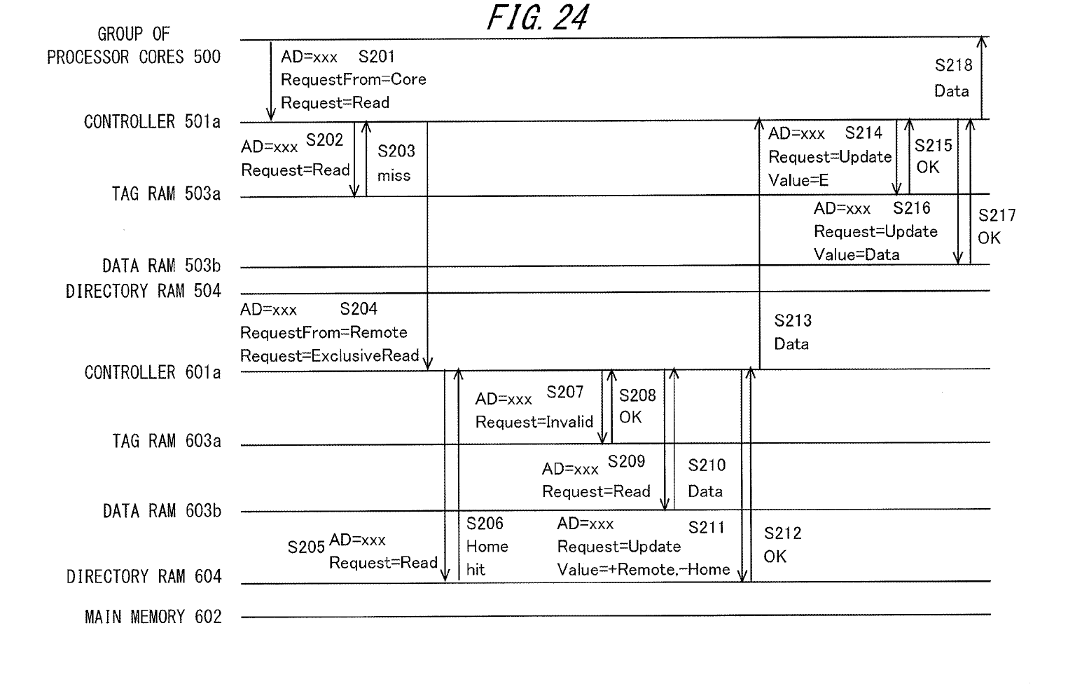

FIG. 23 is a diagram illustrating processed performed by the L2 cache control units 501 and 601 in the process example in FIG. 22. As described above, the L2 cache control units 501 and 601 include the controllers 501a and 601a, registers 501b and 601b, the L2 caches 503 and 603 and the directory RAMs 504 and 604, respectively. In addition, the L2 caches 503 and 603 include the tag RAMs 503a and 603a and the data RAMs 503b and 603b, respectively. Further, the L2 cache control units 501 and 601 include the prefetch control units 501c and 601c, respectively.

FIG. 24 is a timing chart of the L2 cache control units 501 and 601 in the process examples in FIGS. 22 and 23. In S201, the controller 501a of the L2 cache control unit 501 accepts a data acquisition request from an processor core in the group of processor cores 500. The data acquisition request includes the address information indicating in which cluster the data is stored in the memory. In S202, the controller 501a checks the tag RAM 503a to determine whether or not the data corresponding to the address is stored in the data RAM 503b. In S203, the tag RAM 503a returns information indicating that the data is not found in the data RAM 503b (cache miss) to the controller 501a.

In S204, the controller 501a uses the address of the data as the target of the data acquisition request from the group of processor cores 500 to determine that the data is to be stored in the memory 602. Thus, the controller 501a performs an exclusive data acquisition request for the data to the controller 601a.

When the controller 601a receives the exclusive data acquisition request from the controller 501a, the controller 601a, in S205, checks the directory information stored in the directory RAM 604 to determine the status of use of the requested data in the group to which the cluster 60 belongs. The status of use of the data includes information indicating whether or not the data is held by other clusters. In the present embodiment, the directory RAM 604, in S206, checks the directory information to determine that the data is stored in the data RAM 603b (cache hit). And the directory RAM 604 sends the information indicating that the data is stored in the data RAM 603b to the controller 601a.

In S207, the controller 601a requests the tag RAM 603a to invalidate the information indicating that the data is stored in the data RAM 603b (setting to “Invalid”). In S208, the tag RAM 603a updates the information and notifies the controller 601a that the update process is completed. In S209, the controller 601a requests the data RAM 603b to retrieve the data requested from the controller 501a. In S210, the data RAM 603b sends the requested data to the controller 601a.

In S211, the controller 601a requests the directory RAM 604 to update the directory information to indicate that the data is held by the cluster 50 which is Remote (Value=+Remote). In addition, the controller 601a also requests the directory RAM 604 to update the directory information to indicate that the data is not held by the cluster 60 which is Home (Value=−Home). In S212, the directory RAM 604 updates the directory information according to the requests and notifies the controller 601a that the update process is completed. In S213, the controller 601a sends the data to the controller 501a.

In S214, the controller 501a requests the tag RAM 503a to update the information stored in the tag RAM 503a to indicate that the data acquired from the controller 601a is stored in the data RAM 503b. In addition, the controller 501a also requests the tag RAM 503a to register the status of use of the data as “Exclusive”. In S215, the tag RAM 503a performs the requested process and notifies the controller 501a that the process is completed. In S216, the controller 501a requests the data RAM 503b to store the data. In S217, the data RAM 503b stores the data and notifies the controller 501a that the storage process is completed. In S218, the controller 501a sends the data to the processor core requesting the data in the group of processor cores 500.

As described above, since a cluster sends an exclusive data acquisition request to other clusters similar to the comparative example in the present embodiment, there is not a concern for the increase of transactions between clusters.

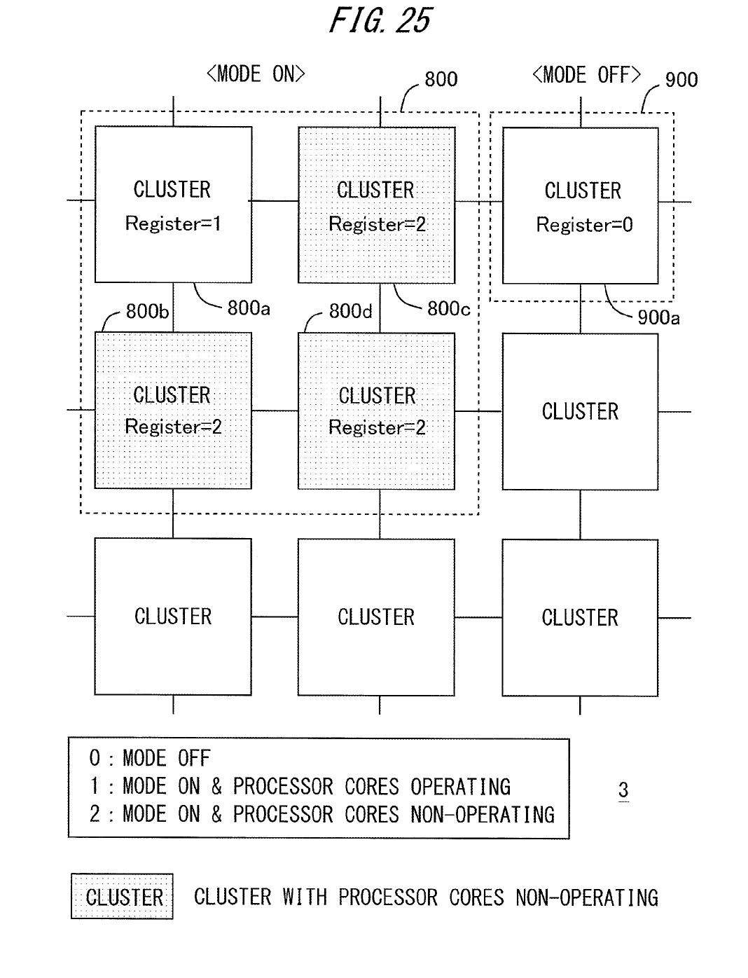

An example of the advantages obtained when the operation mode of each cluster is controlled according to the present embodiment is described with reference to FIG. 25. FIG. 25 illustrates an example in which a plurality of groups of clusters are configured in an information processing apparatus 3. It is noted that the operation mode of each cluster is set according to a setting value of a register in an L2 cache control unit in each cluster. Specifically, the operation mode is set to “mode off” when the setting value is 0, set to “mode on and processor cores operating” when the setting value is 1 and set to “mode on and processor cores non-operating” when the setting value is 2. In FIG. 25, clusters 800a to 800d form a group 800. In addition, a cluster 900a forms a group 900. The group 900 is used for executing an application for which the required memory space is equal to or smaller than the capacity of a main memory in the group 900. Since the configurations of the clusters 800a to 800d and 900a are similar to the configurations of the clusters 50 and 60 as described above, the detailed descriptions and drawings of the components in the clusters are omitted here.

For example, it is assumed that the cluster 900a outside of the group 800 is permitted to access to the cluster 800c inside of the group 800. Further, it is assumed that the cluster 900a sends an exclusive data acquisition request to the cluster 800c to acquire data stored in the L2 cache in the cluster 800c. In this case, the data is moved to the cluster 900a and discarded from the L2 cache in the cluster 800c. In addition, the cluster 800c administers the directory information to indicate that the data is held by the cluster 900a, which is outside of the group 800. In the example as illustrated in FIG. 25, clusters outside of the group are permitted to access to a cluster inside of the group of which the operation mode is “mode on and processor cores operating”. As a result, data stored in the L2 caches in the clusters inside of the group of which the operation modes are “mode on and processor cores non-operating” is not acquired by clusters outside of the group. Thus, there is not a concern that when the cluster of which the operation mode is “mode on and processor cores operating” acquires data in the cluster of which the operation mode is “mode on and processor cores non-operating”, the dada is required to be retrieved from the cluster outside of the group because the data is held by the cluster outside of the group. Consequently, each cluster in the group can effectively acquire data from each other.

In the above comparative example, the groups of processor cores in the clusters which are Remote and Home in addition to the Local clusters are in the operating state. Therefore, the L2 caches in the Local clusters exchange data with other clusters. Thus, the capacity of the L2 cache used by the group of processor cores in the Local cluster is substantively reduced. Further, in the administration of data in the L2 cache, determination criteria and controls are more complicated partially because it is determined which data from which cluster is preferentially acquired or stored in the L2 cache. As a result, the configurations in the comparative example can lead to larger cost-related overhead and performance-related overhead in comparison with the configurations in the present embodiment. Moreover, the data administration involves for example storing additional information indicating from which cluster each data is evicted in the comparative example. To the contrary, the administration of such additional information is not involved in the present embodiment.

Besides, common rules can be applied to both cases in which the operation mode of the group of processor cores is “mode on” and “mode off” for the protocols used for the cache coherence control. For example, it is assumed here that the MESI protocol employing the four states, Modified, Exclusive, Shared and Invalid, is used when the operation mode of the group of processor cores is “mode on”. In this case, this MESI protocol can be used without defining anew state when the operation mode of the group of processor cores is “mode off”. In addition, the control processes can be modified for the “mode on” mode and the “mode off” mode accordingly. Therefore, workload can be reduced when the configurations according to the present embodiment are applied to the configurations according to the comparative example.

Although the present embodiment is described as above, the configurations and the processes of the information processing apparatus are not limited to those as described above and various variations may be made to the embodiment described herein within the technical scope of the present invention. For example, in the above embodiment, the prefetch control unit 601c is provided outside the controller 601a. However, the circuits as illustrated in FIGS. 20A and 20B can be provided inside the controller 601a.

Additionally, as for switching between “mode on” and “mode off”, the operation mode can be set to “mode on” when an application is executed using a large amount of memory space exceeding the capacity of a main memory in a cluster. Therefore, the operation mode is set to “mode off” when an application is executed using memory space which does not exceed the capacity of the memory in the cluster. Thus, appropriate configurations of memories and L2 caches can be employed flexibly for each application in the information processing apparatus. Moreover, efforts for establishing configurations of memories and L2 caches for each application can be omitted.

Further, when the power supply for the group of processor cores is individually controlled for each cluster, the group of processor cores which is set in the non-operating state when the operation mode is set to “mode on” can be turned off. Therefore, unnecessary electricity consumption can be reduced in the information processing apparatus. It is noted that so-called power gating can be employed to control the power supply to each group of processor cores in the above embodiment.

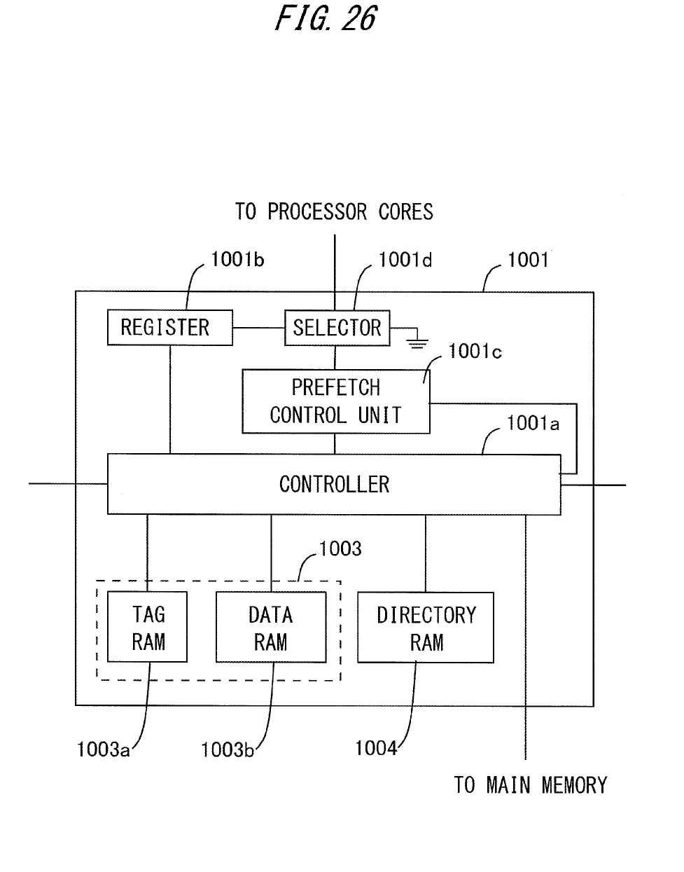

Moreover, in the above descriptions, a register is employed to set a group of processor cores to operating state or non-operating state. Instead of the configurations of the L2 cache control unit as described in the above embodiment, configurations as illustrated in FIG. 26 can be employed to set a group of processor cores to operating state or non-operating state. As illustrated in FIG. 26, an L2 cache control unit 1001 includes a controller 1001a, a register 1001b, a selector 1001c and an L2 cache 1003. In addition, the L2 cache 1003 includes a tag RAM 1003a, a data RAM 1003b and a directory RAM 1004. In the L2 cache control unit 1001, the selector 1001c refers to a setting value of the register 1001b to determine whether requests from the group of processor cores in the cluster, which are not depicted, are blocked or not. For example, when the setting value of the register 1001b is “ON”, the selector 1001c blocks requests from the group of processor cores in the cluster. That is, the group of processor cores can be substantially set to the non-operating state. Further, when the setting value of the register 1001b is “OFF”, the selector 1001c sends requests from the group of processor cores to the controller 1001a. That is, the group of processor cores can be substantially set to the operating state. A configuration in which an application is executed outside of a group of clusters to control the operation mode of each cluster in the group can also be employed in the above embodiment.

<<Computer Readable Recording Medium>>

It is possible to record a program which causes a computer to implement any of the functions described above on a computer readable recording medium. Here, the functions include setting of a register for example. In addition, by causing the computer to read in the program from the recording medium and execute it, the function thereof can be provided. Here, the computer includes clusters and controllers for example.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

An operation processing apparatus, an information processing apparatus and a method of controlling an information processing apparatus according to one embodiment may reduce the access frequency to a main memory.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An operation processing apparatus connected with another operation processing apparatus, comprising:
an operation processing unit configured to perform an operation process using first data administered by the own operation processing apparatus and second data administered by another operation processing apparatus and acquired from another operation processing apparatus;
a main memory configured to store the first data; and
a control unit configured to include a setting unit which sets the operation processing unit to an operating state or a non-operating state and a cache memory which holds the first data and the second data, wherein when the setting unit sets the operation processing unit to the non-operating state and receives a notification related to discarding of the first data from another operation processing apparatus, the control unit acquires the first data which is the target of the notification from the main memory and holds the acquired data in the cache memory.

2. The operation processing apparatus according to claim 1, wherein the control unit acquires data exclusively from another operation processing apparatus when the setting unit sets the operation processing unit to the operating state.

3. An information processing apparatus including an operation processing apparatus connected with another operation processing apparatus, wherein
the operation processing apparatus includes:
an operation processing unit configured to perform an operation process using third data administered by the own operation processing apparatus and fourth data administered by another operation processing apparatus and acquired from another operation processing apparatus,
a main memory configured to store the third data, and
a control unit configured to include a setting unit which sets the operation processing unit to an operating state or a non-operating state and a cache memory which holds the third data and the fourth data, wherein when the setting unit sets the operation processing unit to the non-operating state and receives a notification related to discarding of the third data from another operation processing apparatus, the control unit acquires the third data which is the target of the notification from the main memory and holds the acquired data in the cache memory.

4. The information processing apparatus according to claim 3, wherein the control unit acquires data exclusively from another operation processing apparatus when the setting unit sets the operation processing unit to the operating state.

5. The information processing apparatus according to claim 3, wherein the setting unit in one of the plurality of operation processing apparatus sets the operation processing unit in the one of the plurality of operation processing apparatus to the operating state and the setting unit in the other operation processing apparatus sets the operation processing unit in the other operation processing apparatus to the non-operating state.

6. The information processing apparatus according to claim 3, wherein a group is formed to include a first operation processing apparatus in which the setting unit sets the operation processing unit to the operating state and a second operation processing apparatus in which the setting unit sets the operation processing unit to the non-operating state, and
when a third operation processing apparatus accesses to an operation processing apparatus in the group, the third operation processing apparatus accesses to the first operation processing apparatus and does not access to the second processing apparatus.

7. A method of controlling an information processing apparatus, the method comprising:
setting by a processor an operation processing unit of a first operation processing apparatus included in the information processing apparatus to an operating state or a non-operating state, the operation processing unit performing an operation process using fifth data administered by the first operation processing apparatus and sixth data administered by a second operation processing apparatus connected with the first operation processing apparatus and acquired from the second operation processing apparatus;
receiving by a processor a notification related to discarding of the fifth data from the second operation processing apparatus after the operation processing unit of the first operation processing apparatus is set to the non-operating state; and
acquiring by a processor the fifth data as the target of the notification from a main memory of the first operation processing apparatus and storing the acquired data in a cache memory of the first operation processing apparatus when the notification is received.

8. The method of controlling the information processing apparatus according to claim 7, wherein the second data is exclusively acquired from the second operation processing apparatus when the operation processing unit of the first operation processing apparatus is set to the operating state.

9. The method of controlling the information processing apparatus according to claim 7, wherein when the operation processing unit in one of the first and second operation processing apparatus is set to the operating state the operation processing unit in the other operation processing apparatus is set to the non-operating state.

10. The method of controlling the information processing apparatus according to claim 7, wherein a group is formed to include the first operation processing apparatus in which the setting unit sets the operation processing unit to the operating state and the second operation processing apparatus in which the setting unit sets the operation processing unit to the non-operating state, and
when a third operation processing apparatus accesses to one of the operation processing apparatus in the group, the third operation processing apparatus accesses to the first operation processing apparatus and does not access to the second processing apparatus.
